(19) United States
(12) Patent Application Publication
(10) Pub. No.: US 2021/0381577 A1
(43) Pub. Date: Dec. 9, 2021

(54) VIBRATION ISOLATING DEVICE

(71) Applicant: Sumitomo Riko Company Limited, Aichi (JP)

(72) Inventors: Hiroyuki ICHIKAWA, Aichi (JP); Takashi KUME, Aichi (JP)

(73) Assignee: Sumitomo Riko Company Limited, Aichi (JP)

(21) Appl. No.: 17/408,479

(22) Filed: Aug. 22, 2021

Related U.S. Application Data
(63) Continuation of application No. PCT/JP2021/005051, filed on Feb. 10, 2021.

(30) Foreign Application Priority Data
May 27, 2020 (JP) 2020-092365

(51) Int. Cl. F16F 13/30; B60K 5/12; F16F 13/10

(52) U.S. Cl. CPC F16F 13/305; F16F 13/10; B60K 5/1283

(57) ABSTRACT

A vibration isolating device is provided. An inner shaft member and an outer tube member are connected to each other with a main body rubber elastic body and plural fluid chambers filled with a fluid are provided to be separated from each other in a circumferential direction and communicates with each other through an orifice passage. The fluid is a magnetically functional fluid. The outer tube member is a non-magnetic material. A tubular cover member is disposed to be separated toward an outer circumferential side from the outer tube member. A magnetic field generating unit exerting a magnetic field on the magnetically functional fluid is assembled between the outer tube member and the tubular cover member. One side member and another side member to be connected to each other in a vibration isolating manner are configured to be attached to the inner shaft member and the tubular cover member.

### CROSS-REFERENCE TO RELATED APPLICATION

The present application is a continuation of PCT/JP2021/005051, filed on Feb. 10, 2021, and is related to and claims priority from Japanese patent application no. 2020-092365, filed on May 27, 2020. The entire contents of the aforementioned application are hereby incorporated by reference herein.

### TECHNICAL FIELD

The present invention relates to a vibration isolating device applied to an engine mount or the like, and particularly relates to a fluid-filled type vibration isolating device that utilizes a flow action of a fluid which fills an internal fluid chamber.

### BACKGROUND

In the related art, a fluid-filled type vibration isolating device is known as a kind of a vibration isolating device which is interposed between members constituting a vibration transmission system and connects them to each other in a vibration isolating manner. The vibration isolating device has a structure in which an inner shaft member and an outer tube member are connected to each other with a main body rubber elastic body. Further, in the fluid-filled type vibration isolating device, a plurality of fluid chambers filled with a fluid is provided to be separated from each other in a circumferential direction, and the fluid chambers communicate with each other through an orifice passage. The fluid flow through the orifice passage is generated along with relative pressure fluctuation of the plurality of fluid chambers due to an input of vibration, and thus a vibration isolating effect based on a flow action of the fluid is exhibited. A fluid-filled type vibration isolating device is shown in, for example, Japanese Patent Application Laid-Open No. H03-009139 (Patent Literature 1).

Incidentally, in the vibration isolating device of Patent Literature 1, an electro-rheological fluid whose viscosity changes with energization is employed as the fluid which fills the fluid chamber. By controlling the energization of the electro-rheological fluid according to input vibration and switching spring properties of the vibration isolating device, it is possible to realize excellent vibration isolating performance, traveling stability, and the like.

However, it is necessary to pass an electric current to the electro-rheological fluid to control the viscosity thereof, it is necessary to provide an electrode for energization inside the vibration isolating device such that the electrode is brought into contact with the electro-rheological fluid, and it is necessary to lead a wiring for passing an electric current through the electrode to the inside of the vibration isolating device at which the electrode is arranged, and thus a structure of the vibration isolating device tends to be complicated.

### SUMMARY

The present disclosure is to provide a vibration isolating device having a structure capable of realizing excellent vibration isolating performance by controlling properties with a simple structure.

Hereinafter, several embodiments for understanding the disclosure will be described, but the aspects which will be described below are described as an example and can be employed by being appropriately combined with each other, and a plurality of constituent elements which will be described in each embodiment can be recognized and employed independently as much as possible and can be employed by being appropriately combined with any constituent elements described in another aspect. Therefore, the disclosure is not limited to the aspects which will be described below, and various other aspects can be realized.

According to one embodiment of the disclosure, there is provided a fluid-filled type vibration isolating device in which an inner shaft member and an outer tube member are connected to each other with a main body rubber elastic body and a plurality of fluid chambers filled with a fluid is provided to be separated from each other in a circumferential direction and communicates with each other through an orifice passage, wherein the fluid is a magnetically functional fluid, wherein the outer tube member is a non-magnetic material, wherein a tubular cover member is disposed to be separated toward an outer circumferential side from the outer tube member, wherein a magnetic field generating unit that exerts a magnetic field on the magnetically functional fluid is assembled between the outer tube member and the tubular cover member, and wherein one side member and another side member to be connected to each other in a vibration isolating manner are configured to be attached to the inner shaft member and the tubular cover member.

According to another embodiment of the disclosure, there is provided a fluid-filled type vibration isolating device in which an inner shaft member and an outer tube member are connected to each other with a main body rubber elastic body and a plurality of fluid chambers filled with a fluid is provided to be separated from each other in a circumferential direction and communicates with each other through an orifice passage, wherein the fluid is a magnetically functional fluid, wherein the outer tube member is a non-magnetic material, wherein a magnetic field generating unit that exerts a magnetic field on the magnetically functional fluid is mounted on an outer circumferential side of the outer tube member, and wherein a magnetic flux concentrating member formed of a ferromagnetic material is disposed on a wall portion of the orifice passage.

### BRIEF DESCRIPTION OF DRAWINGS

FIG. 1 is a cross-sectional view showing an engine mount as a first embodiment of the present invention, which corresponds to a cross section along line I-I of FIG. 2.

FIG. 2 is a cross-sectional view along line II-II of FIG. 1.

FIG. 3 is a perspective view of a mount main body and a magnetic flux concentrating member which constitute the engine mount shown in FIG. 1.

FIG. 4 is a cross-sectional view showing an engine mount as a second embodiment of the present invention, which corresponds to a cross section along line IV-IV of FIG. 5.

FIG. 5 is a cross-sectional view along line V-V of FIG. 4.

FIG. 6 is a perspective view of a mount main body and an orifice member which constitute the engine mount shown in FIG. 4.

FIG. 7 is a plan view of an orifice member which constitutes the engine mount shown in FIG. 4.

FIG. 8 is a cross-sectional view showing an engine mount as a third embodiment of the present invention.

FIG. 9 is a plan view of an orifice member which constitutes the engine mount shown in FIG. 8.

FIG. 10 is a perspective view of a mount main body and a magnetic flux concentrating member which constitute an engine mount as a fourth embodiment of the present invention.

FIG. 11 shows a magnetic flux concentrating member in FIG. 10, in which (a) is a perspective view, (b) is a front view, (c) is a side view, and (d) is a cross-sectional view along line XI(d)-XI(d) in (b).

FIG. 12 is a perspective view of a mount main body and a magnetic flux concentrating member which constitute an engine mount as a fifth embodiment of the present invention.

FIG. 13 is a vertical cross-sectional view of a mount main body and a magnetic flux concentrating member in FIG. 12.

FIG. 14 is a cross-sectional view along line XIV-XIV in FIG. 13.

FIG. 15 shows a magnetic flux concentrating member in FIG. 12, in which (a) is a perspective view, (b) is a front view, (c) is a plan view, (d) is a side view, and (e) is a cross-sectional view along line XV(e)-XV(e) in (c).

FIG. 16 is a perspective view of a mount main body and a magnetic flux concentrating member which constitute an engine mount as a sixth embodiment of the present invention.

FIG. 17 shows a magnetic flux concentrating member in FIG. 16, in which (a) is a perspective view, (b) is a front view, (c) is a plan view, (d) is a side view, and (e) is a cross-sectional view along line XVII(e)-XVII(e) in (c).

FIG. 18 is a cross-sectional view showing a part of an engine mount as another embodiment of the present invention.

### DESCRIPTION OF EMBODIMENTS

Hereinafter, embodiments of the present invention will be described with reference to the drawings.

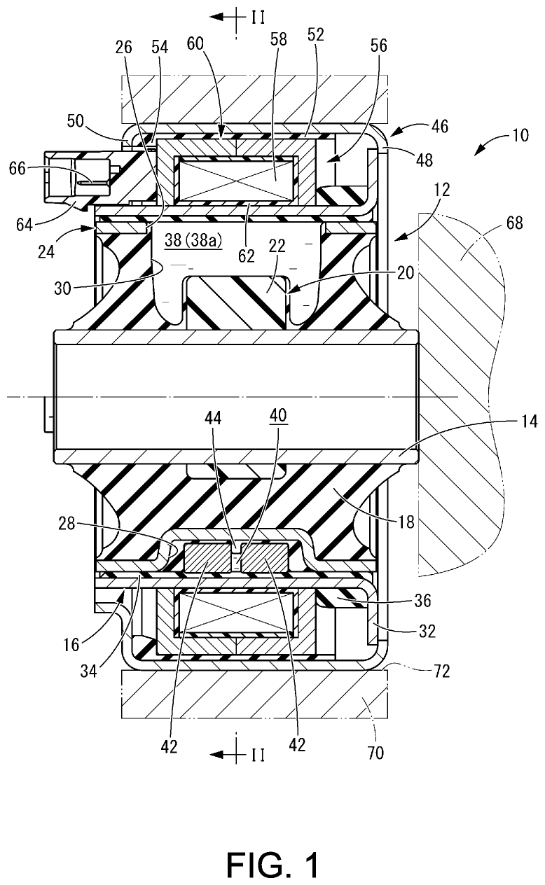

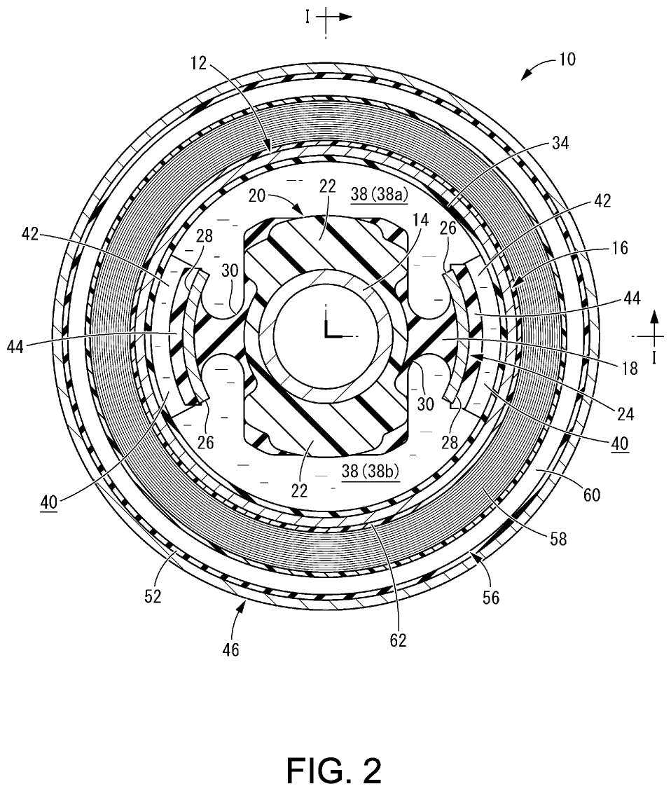

FIGS. 1 and 2 show an engine mount 10 for an automobile as a first embodiment of a vibration isolating device having a structure according to the present invention. The engine mount 10 is a fluid-filled type vibration isolating device and includes a mount main body 12. The mount main body 12 has a structure in which an inner shaft member 14 and an outer tube member 16 are connected to each other with a main body rubber elastic body 18. In the following description, in principle, an axial direction refers to a horizontal direction in FIG. 1 which is a central axial direction of the mount, and a vertical direction refers to a vertical direction in FIG. 2 which is a main vibration input direction.

The inner shaft member 14 has a substantially cylindrical shape with a small diameter and extends linearly in the axial direction. The inner shaft member 14 is desirably formed of a non-magnetic material and is formed of, for example, stainless steel, an aluminum alloy, or the like. A stopper member 20 is fixed to the central portion of the inner shaft member 14 in the axial direction. The stopper member 20 has an annular shape as a whole and includes two protruding portions 22 and 22 that project toward both sides in the vertical direction in which two fluid chambers 38 and 38 which will be described later are arranged, as shown in FIG. 2.

As shown in FIGS. 1 and 2, an intermediate sleeve 24 is arranged around the inner shaft member 14. The intermediate sleeve 24 has a substantially cylindrical shape having a diameter larger than that of the inner shaft member 14 and is disposed in an externally fitted state in which the intermediate sleeve 24 is separated toward an outer circumferential side with respect to the inner shaft member 14 on the entire periphery. The intermediate sleeve 24 is provided with window parts 26 at two locations in a circumferential direction. The window parts 26 penetrate the intermediate sleeve 24 in a radial direction at the central portion of the intermediate sleeve 24 in the axial direction. A groove-shaped portion 28 is provided between the two window parts 26 and 26 in the intermediate sleeve 24 in the circumferential direction. The groove-shaped portion 28 is a portion formed in a recessed groove shape which is partially reduced in diameter and is open to an outer circumferential surface in the intermediate sleeve 24 and extends in the circumferential direction on the central portion of the intermediate sleeve 24 in the axial direction, and both end portions of the groove-shaped portion 28 in the circumferential direction reach each one side of the two window parts 26 and 26. Similar to the inner shaft member 14, the intermediate sleeve 24 is desirably formed of a non-magnetic material and is formed of, for example, stainless steel, an aluminum alloy, or the like.

The inner shaft member 14 and the intermediate sleeve 24 are connected to each other with the main body rubber elastic body 18. The main body rubber elastic body 18 has a substantially cylindrical shape, an inner circumferential portion thereof is fixed to the inner shaft member 14, and an outer circumferential portion thereof is fixed to the intermediate sleeve 24. Further, the main body rubber elastic body 18 covers a groove inner surface of the groove-shaped portion 28 in the intermediate sleeve 24 and is also fixed to the outer circumferential surface of the intermediate sleeve 24 in the groove-shaped portion 28. The main body rubber elastic body 18 can be formed as an integrally vulcanized molded product including the inner shaft member 14 and the intermediate sleeve 24.

As shown in FIG. 2, the main body rubber elastic body 18 includes two pocket-shaped portions 30 and 30. The pocket-shaped portion 30 is formed in a recess shape which is open to an outer circumferential surface of the main body rubber elastic body 18, and in the present embodiment, the pocket-shaped portion 30 is open toward both sides in the vertical direction. The pocket-shaped portion 30 is provided at a position corresponding to the window part 26 of the intermediate sleeve 24, an opening peripheral edge portion of the pocket-shaped portion 30 is fixed to the window part 26, and the pocket-shaped portion 30 is open toward the outer circumferential side through the window part 26. The protruding portion 22 of the stopper member 20 protrudes from an inner circumferential bottom portion of the pocket-shaped portion 30.

The outer tube member 16 is externally fitted and fixed to the intermediate sleeve 24 fixed to the main body rubber elastic body 18. The outer tube member 16 has a substantially cylindrical shape having a diameter larger than that of the inner shaft member 14. One end portion of the outer tube member 16 in the axial direction includes a flange-shaped portion 32 that protrudes toward the outer circumferential side. The outer tube member 16 is formed of a non-magnetic material and is formed of, for example, stainless steel, an aluminum alloy, or the like.

An inner circumferential surface of the outer tube member 16 is covered with a seal rubber layer 34. Further, a first end portion elastic body 36 is provided as an end portion elastic body at one end portion of the outer tube member 16 in the axial direction. The first end portion elastic body 36 is an annular rubber or resin elastomer and is fixed to an outer circumferential surface of the outer tube member 16 and a surface of an inner circumferential portion of the flange-shaped portion 32. In the present embodiment, the seal rubber layer 34 and the first end portion elastic body 36 are integrally formed.

The outer tube member 16 is mounted on the intermediate sleeve 24 in an externally fitted state and is fitted to the outer circumferential surface of the intermediate sleeve 24 by, for example, a diameter reduction process such as eight-way drawing. Further, the seal rubber layer 34 is sandwiched between the outer tube member 16 and the intermediate sleeve 24, and thus the portion therebetween is fluid-tightly sealed.

The window part 26 of the intermediate sleeve 24 is fluid-tightly covered with the outer tube member 16. As a result, a first fluid chamber 38a and a second fluid chamber 38b are formed as two fluid chambers 38, 38 between the inner shaft member 14 and the outer tube member 16. In each of the fluid chambers 38a and 38b, the wall portions on both sides in the axial direction are formed with the main body rubber elastic body 18. Further, in each of the fluid chambers 38a and 38b, the protruding portion 22 of the stopper member 20 protrudes from the inside toward the outside in the radial direction. The first and second fluid chambers 38a and 38b are provided to be separated from each other in the circumferential direction and, in the present embodiment, are arranged on both sides of the inner shaft member 14 in the vertical direction, that is, both sides in a direction perpendicular to the central axis of the mount.

Each of the fluid chambers 38a and 38b is filled with a magnetically functional fluid. The magnetically functional fluid is a fluid whose viscosity increases due to the action of a magnetic field. The magnetically functional fluid may be any of a magneto-rheological fluid (MRF), a magnetic fluid (MF), and a magnetic composite fluid (MCF) obtained by mixing the magneto-rheological fluid and the magnetic fluid with each other. As the magnetically functional fluid, a magnetically functional fluid in which a viscosity changes greatly with the action of a magnetic field is desirable, but a magnetic composite fluid in which an increase width of a viscosity can be easily adjusted by the mixing ratio of the magneto-rheological fluid and the magnetic fluid may be also employed.

The magnetically functional fluid is, for example, a suspension or colloidal solution in which ferromagnetic fine particles are dispersed in a base liquid such as water or oil, and it is desirable that the surfaces of the ferromagnetic fine particles be coated with a surfactant, or that the ferromagnetic fine particles be dispersed in the base liquid to which a surfactant is added such that the ferromagnetic fine particles are unlikely to aggregate or settle in the base liquid.

The ferromagnetic fine particles are, for example, metal particles such as iron, ferrite, and magnetite and may have a particle size of about 8 nm to 10 μm. The base liquid is not particularly limited as long as it can disperse ferromagnetic fine particles, and for example, water, isoparaffin, alkylnaphthalene, perfluoropolyether, polyolefin, silicone oil, and the like can be employed. Further, it is desirable that the base liquid be an incompressible fluid. The surfactant is appropriately selected according to the base liquid, and for example, oleic acid and the like may be employed. The magneto-rheological fluid and the magnetic fluid are different from each other mainly in a particle size of the ferromagnetic fine particles, and the magneto-rheological fluid has a larger particle size of the ferromagnetic fine particles than that of the magnetic fluid.

The first and second fluid chambers 38a and 38b communicate with each other through an orifice passage 40. The orifice passage 40 extends in the circumferential direction between the outer tube member 16 and the intermediate sleeve 24, and both end portions thereof in the circumferential direction communicate with each of the first and second fluid chambers 38a and 38b. A region for forming the orifice passage 40 is formed by fluid-tightly sealing an outer peripheral opening of the groove-shaped portion 28 provided in the intermediate sleeve 24 with the outer tube member 16. In the present embodiment, a pair of orifice passages 40 and 40 is provided on both sides of the first fluid chamber 38a in the circumferential direction and causes the first fluid chamber 38a and the second fluid chamber 38b to communicate with each other in the circumferential direction. That is, the pair of orifice passages 40 and 40 is also provided on both sides of the second fluid chamber 38b in the circumferential direction and is provided on both sides in a direction orthogonal to a facing direction of the first fluid chamber 38a and the second fluid chamber 38b (a horizontal direction in FIG. 2) in the direction perpendicular to the central axis of the mount. Therefore, these orifice passages 40 and 40 cause the first fluid chamber 38a and the second fluid chamber 38b to communicate with each other in parallel on both sides in the radial direction, and it is possible to dispose the first and second fluid chambers 38a and 38b and the orifice passages 40 and 40 without increasing the size of the engine mount 10. Further, in the present embodiment, the pair of orifice passages 40 and 40 is formed with the same passage cross-sectional area and passage length, but the passage cross-sectional area and/or the passage length in both orifice passages may be different from each other.

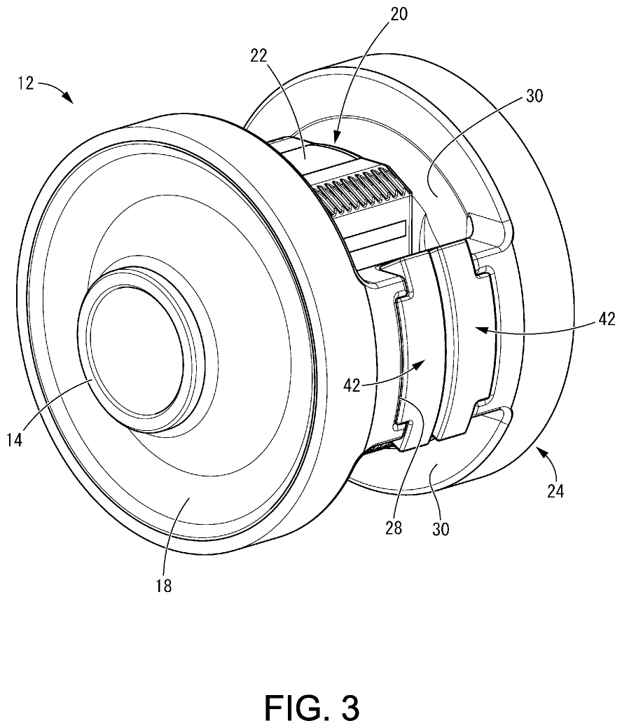

Further, the wall portions on both sides of the orifice passage 40 in the axial direction are each formed with a magnetic flux concentrating member 42. The magnetic flux concentrating member 42 is formed of a ferromagnetic material such as iron. The magnetic flux concentrating member 42 of the present embodiment has a substantially quadrangular cross section and extends in the circumferential direction over the entire length of the groove-shaped portion 28 in the circumferential direction. As shown in FIGS. 1 and 3, a set of magnetic flux concentrating members 42 and 42 are disposed inside the groove-shaped portion 28 to be separated from each other in the axial direction and face each other, and the orifice passage 40 extending in the circumferential direction is formed between these magnetic flux concentrating members 42 and 42. It is desirable that the magnetic flux concentrating members 42 and 42 be positioned with respect to each other in the axial direction. In the present embodiment, a positioning protrusion 44 that protrudes toward the outer periphery from the rubber elastic body covering the groove inner surface of the groove-shaped portion 28 is provided, and the magnetic flux concentrating members 42 and 42 are positioned with respect to each other in the axial direction by coming into contact with the position protrusion 44 from both sides in the axial direction. The magnetic flux concentrating members 42 and 42 may be positioned with respect to each other by being connected to each other with a non-magnetic material such as rubber.

A tubular cover member 46 is attached to the mount main body 12. The tubular cover member 46 has a substantially cylindrical shape as a whole and is formed of a non-magnetic material such as stainless steel or an aluminum alloy. The tubular cover member 46 has a first inner curved portion 48 in which one end portion in the axial direction protrudes toward the inner periphery, and a second inner curved portion 50 in which the other end portion in the axial direction protrudes toward the inner periphery.

The tubular cover member 46 is fixed to the outer tube member 16. That is, the tubular cover member 46 is arranged in an externally fitted state with respect to the outer tube member 16 and extends in the circumferential direction at a position separated toward the outer periphery with respect to the outer tube member 16. Further, the first inner curved portion 48 of the tubular cover member 46 is superposed on an outer surface of the flange-shaped portion 32 of the outer tube member 16 in the axial direction, and thus the outer tube member 16 and the tubular cover member 46 are positioned in the axial direction.

An outer circumferential elastic layer 52 is fixed to the inner circumferential surface of the tubular cover member 46. The outer circumferential elastic layer 52 is a thin rubber layer having a substantially cylindrical shape and is arranged at an intermediate portion of the tubular cover member 46 in the axial direction. A second end portion elastic body 54 as an end portion elastic body is fixed to another end portion of the tubular cover member 46. The second end portion elastic body 54 is integrally formed with the outer circumferential elastic layer 52 and is fixed to an inner circumferential surface of another end portion of the tubular cover member 46 in the axial direction and an inner surface of the second inner curved portion 50 in the axial direction.

A magnetic field generating unit 56 is arranged between the outer tube member 16 and the tubular cover member 46 in the radial direction. The magnetic field generating unit 56 has an annular shape as a whole and has a structure in which a yoke member 60 is attached around a coil 58.

The coil 58 has a cylindrical shape or an annular shape as a whole and has a structure in which an electric wire formed of a conductive material is wound. The coil 58 is formed by being wound around a bobbin 62 made of synthetic resin. The coil 58 is desirably formed of a material having excellent electrical conductivity and may be formed of, for example, copper, an aluminum alloy, or the like. The coil 58 is conducted to a terminal portion 66 of a connector 64 that protrudes outward in the axial direction from the second inner curved portion 50 of the tubular cover member 46 and is electrically connected to an external energization control device (not shown) via the connector 64.

The yoke member 60 is formed of a ferromagnetic material such as iron. The yoke member 60 has a U-shaped cross section which is open toward the inner periphery and is arranged to cover both end surfaces in the axial direction and the outer circumferential surface of the coil 58. As a result, when a current flows to the coil 58 in the circumferential direction, a magnetic flux of the coil 58 is guided to the yoke member 60 which is a ferromagnet, that is, a magnetic path is formed by the yoke member 60, and leakage of magnetic flux to the outer side in the axial direction and the outer periphery is reduced. The yoke member 60 of the present embodiment has a divided structure such that it can be mounted on the coil 58.

As shown in FIGS. 1 and 2, the magnetic field generating unit 56 is mounted on the outer circumferential side of the outer tube member 16 and is assembled between the outer tube member 16 and the tubular cover member 46. That is, the magnetic field generating unit 56 is externally fitted with respect to the outer tube member 16 to be disposed thereon, the inner circumferential surface thereof is superposed on the outer circumferential surface of the outer tube member 16, and the outer circumferential surface thereof is superposed on the inner circumferential surface of the tubular cover member 46 via the outer circumferential elastic layer 52. As a result, the yoke member 60 is open toward the outer tube member 16 located on the inner circumferential side. The magnetic field generating unit 56 is sandwiched between the outer tube member 16 and the tubular cover member 46 in the radial direction and is positioned with respect to the outer tube member 16 in the radial direction. In the magnetic field generating unit 56, the outer circumferential elastic layer 52 is interposed in the radial sandwiching between the outer tube member 16 and the tubular cover member 46, and thus a force exerted by the radial sandwiching is adjusted.

Further, in the magnetic field generating unit 56, one end surface thereof in the axial direction is superposed on the flange-shaped portion 32 of the outer tube member 16 via the first end portion elastic body 36, and another end surface in the axial direction is superposed on the second inner curved portion 50 of the tubular cover member 46 via the second end portion elastic body 54. As a result, the magnetic field generating unit 56 is sandwiched between the outer tube member 16 and the tubular cover member 46 in the axial direction and is positioned with respect to the mount main body 12 in the axial direction. In the magnetic field generating unit 56, the first and second end portion elastic bodies 36 and 54 are interposed in the axial sandwiching between the outer tube member 16 and the tubular cover member 46, and thus a force exerted by the axial sandwiching is adjusted.

The engine mount 10 is attached to a vehicle, for example, by the inner shaft member 14 being attached to a power unit 68 which is a member on one side to be connected in a vibration isolating manner and the tubular cover member 46 fixed to the outer tube member 16 being attached to a vehicle body 70 which is a member on another side to be connected in a vibration isolating manner. The tubular cover member 46 is fixed to the vehicle body 70, for example, by being press-fitted into a mounting hole 72 of the vehicle body 70. The inner shaft member 14 may be attached to the power unit 68 via an inner bracket (not shown). Similarly, the tubular cover member 46 may be attached to the vehicle body 70 via an outer bracket (not shown).

In the attached state of the engine mount 10 to the vehicle, when the vibration in the vertical direction in which the first and second fluid chambers 38a and 38b are arranged is input to the engine mount 10, flow of the filled fluid through the orifice passage 40 occurs between the first and second fluid chambers 38a and 38b, and a vibration isolating effect based on a flow action of the fluid is exhibited.

The engine mount 10 is capable of controlling the magnetic field exerted on the magnetically functional fluid flowing through the orifice passage 40 by the magnetic field generating unit 56, whereby the viscosity of the magnetically functional fluid can be controlled.

The control of the viscosity of the magnetically functional fluid by the magnetic field generating unit 56 is realized by controlling the energization to the coil 58.

That is, the magnetic field formed around the coil 58 by the energization to the coil 58 forms a magnetic pole at each of the inner circumferential ends of the yoke member 60 arranged around the coil 58. The magnetic flux between the magnetic poles of the yoke member 60 is guided to the magnetic flux concentrating members 42 and 42 each of which is a ferromagnet. Since the magnetic flux concentrating members 42 and 42 are apart from each other in the axial direction and the orifice passage 40 is arranged between the magnetic flux concentrating members 42 and 42, the magnetic flux guided by the magnetic flux concentrating members 42 and 42 passes through the orifice passage 40 concentratedly. In other words, since the magnetic flux concentrating members 42 and 42 are disposed on the wall portions of the orifice passage 40, the magnetic flux in the magnetic field exerted from the magnetic field generating unit 56 is guided to the orifice passage 40 by the magnetic flux concentrating members 42 and 42. Therefore, the magnetic field formed by the energization to the coil 58 is efficiently exerted on the magnetically functional fluid in the orifice passage 40.

The viscosity of the magnetically functional fluid increases depending on the strength of the exerted magnetic field. Therefore, it is possible to control the viscosity of the magnetically functional fluid by controlling the strength of the current flowing through the coil 58. The upper limit of the strength of the magnetic field exerted on the magnetically functional fluid can be adjusted with the number of turns and material of the coil 58, the maximum value of the current flowing through the coil 58, and the like.

In the present embodiment, since the side wall portions on both sides in the axial direction of the orifice passage 40 extending in the circumferential direction are the magnetic flux concentrating members 42 and 42, the magnetic flux guided by the magnetic flux concentrating members 42 and 42 passes through the orifice passage 40 concentratedly. As a result, a stronger magnetic field is exerted on the magnetically functional fluid in the orifice passage 40, and the viscosity of the magnetically functional fluid can be efficiently controlled by the magnetic field generating unit 56 arranged on the outer periphery of the mount main body 12.

Further, since the orifice passage 40 extends in the circumferential direction and the magnetic field generating unit 56 is annular, it is possible to exert the magnetic field to the magnetically functional fluid in the orifice passage 40 over a wide range in the circumferential direction and to efficiently control the viscosity of the magnetically functional fluid. Further, it is possible to effectively exert the magnetic field generated by the magnetic field generating unit 56 to the magnetically functional fluid in the orifice passage 40 without positioning the magnetic field generating unit 56 and the orifice passage 40 in the circumferential direction.

The region for forming the orifice passage 40 is provided between the intermediate sleeve 24 and the outer tube member 16, and the outer tube member 16 and the intermediate sleeve 24 are both formed of a non-magnetic material. As a result, it is possible to concentrate the magnetic flux to the magnetic flux concentrating members 42 and 42 without forming a magnetic path by the outer tube member 16 and the intermediate sleeve 24. Therefore, it is possible to efficiently exert the magnetic field to the magnetically functional fluid in the orifice passage 40 and to control the viscosity of the magnetically functional fluid.

By controlling the energization to the coil 58 and controlling the viscosity of the magnetically functional fluid flowing through the orifice passage 40, it is possible to switch and control the performance (the vibration isolating properties) of the engine mount 10. A switching mode of the performance of the engine mount 10 is not particularly limited, and the performance may be switched to satisfy desired performance. One mode of switching control will be illustrated below.

First, at the time of an idling vibration input in which medium to high frequency vibration is input or in a normal running state, the coil 58 is not energized and the viscosity of the magnetically functional fluid in the orifice passage 40 becomes small. Accordingly, the flow resistance of the magnetically functional fluid in the orifice passage 40 becomes small, and the low-viscosity magnetically functional fluid actively flows through the orifice passage 40. As a result, the spring properties of the engine mount 10 are softened, and a good ride quality is realized by the vibration insulation effect due to the low dynamic spring.

When a low-frequency and large-amplitude vibration corresponding to engine shake is input, the coil 58 is energized to increase the viscosity of the magnetically functional fluid in the orifice passage 40. As a result, the flow resistance of the magnetically functional fluid in the orifice passage 40 becomes large, and the resonance phenomenon related to the flow of the magnetically functional fluid in the orifice passage 40 is exhibited at a lower frequency. Therefore, the magnetically functional fluid with increased viscosity flows through the orifice passage 40, and thus a vibration damping action against the low-frequency vibration is effectively exhibited, and the vibration isolating effect due to the damping of vibration energy is exhibited.

Further, when the power unit 68 is largely roll-displaced due to a sudden start of the vehicle or the like, the coil 58 is energized to increase the viscosity of the magnetically functional fluid in the orifice passage 40, thereby hardening the spring properties of the engine mount 10. As a result, the swing of the power unit 68 can be suppressed, and the steering stability and ride quality of the vehicle can be improved.

In this way, the engine mount 10 controls the energization to the coil 58 in response to the input vibration, and thus it is possible to realize excellent vibration isolating performance by appropriately switching soft spring properties having excellent vibration insulation performance and hard spring properties having excellent vibration damping performance and excellent support stability of the power unit 68. In the present embodiment, the switching of ON and OFF of energization to the coil 58 has been illustrated, however, by controlling not only ON and OFF of the energization to the coil 58 but also the strength of the current flowing through the coil 58, it is possible to switch the properties of the engine mount 10 in more detail. Specifically, for example, in the above-described switching example of the properties, a current is passed through the coil 58 at the time of inputting the engine shake and at the time of roll displacement of the power unit 68, but it is also possible to make the strengths of the currents flowing through the coil 58 different from each other. That is, for example, when the roll displacement of the power unit 68 is performed, a stronger current may be passed than when the engine shake is input, and thus the roll displacement of the power unit 68 may be suppressed more effectively.

The magnetic field generating unit 56 that exerts a magnetic field on the magnetically functional fluid is arranged on the outer circumferential side of the outer tube member 16 and is not arranged in each of the fluid chambers 38a and 38b. In a structure of the present embodiment, the magnetic field generating unit 56 is independently and separately provided with respect to the mount main body 12 including a region filled with the magnetically functional fluid such as the fluid chambers 38a and 38b and the orifice passage 40. In this way, since the mount main body 12 which is a portion which is filled with the fluid and the magnetic field generating unit 56 which is a portion which generates the magnetic field are separated from each other, it is possible to simplify the structure as compared with the case in which the magnetic field generating unit is built in.

In particular, since the magnetic field generating unit 56 that exerts a magnetic field on the magnetically functional fluid is provided on the outer circumferential side of the mount main body 12, it is possible to easily provide the connector 64 for energizing the magnetic field generating unit 56, a wiring (not shown) which is connected to the connector 64, and the like.

The tubular cover member 46 attached to the outer tube member 16 is arranged on the outer circumferential side of the magnetic field generating unit 56, and the magnetic field generating unit 56 is assembled between the outer tube member 16 and the tubular cover member 46. Therefore, in a structure in which the magnetic field generating unit 56 is arranged on the outer circumferential side of the outer tube member 16, the tubular cover member 46 is fixed to the vehicle body 70 by a means such as being press-fitted into the mounting hole 72, and thus the attachment of the engine mount 10 to the vehicle body 70 is realized. Further, by the providing of the tubular cover member 46 on the outer circumferential side of the magnetic field generating unit 56, the magnetic field generating unit 56 is protected by the tubular cover member 46 in the engine mount 10 before being mounted on the vehicle.

The tubular cover member 46 is formed of a non-magnetic material such as stainless steel. Since the tubular cover member 46 arranged in the vicinity of the magnetic field generating unit 56 is formed of a non-magnetic material, the escape of the magnetic flux generated by the magnetic field generating unit 56 to the outer circumferential side from the yoke member 60 is reduced, and thus it is possible to efficiently exert the magnetic flux to the magnetically functional fluid on the inner circumferential side from the magnetic field generating unit 56.

The outer circumferential surface of the magnetic field generating unit 56 is superposed on the tubular cover member 46 via the outer circumferential elastic layer 52. Therefore, when the magnetic field generating unit 56 is sandwiched between the outer tube member 16 and the tubular cover member 46 in the direction perpendicular to the axis, the force acting on the magnetic field generating unit 56 is relieved by the elasticity of the outer circumferential elastic layer 52, and the distortion of the magnetic field generating unit 56 is reduced. Further, since a contact reaction force exerted on the outer tube member 16 and the tubular cover member 46 is also reduced by the magnetic field generating unit 56 being sandwiched therebetween in the direction perpendicular to the axis, the distortion of the outer tube member 16 and the tubular cover member 46 is also reduced.

Since the annular magnetic field generating unit 56 is externally fitted to the outer tube member 16, the magnetic field generating unit 56 can be easily positioned with respect to the outer tube member 16 in the direction perpendicular to the axis.

In the magnetic field generating unit 56, one end surface thereof in the axial direction is superposed on the flange-shaped portion 32 of the outer tube member 16 via the first end portion elastic body 36, and another end surface in the axial direction is superposed on the second inner curved portion 50 of the tubular cover member 46 via the second end portion elastic body 54. The magnetic field generating unit 56 is sandwiched between the flange-shaped portion 32 of the outer tube member 16 and the second inner curved portion 50 of the tubular cover member 46 in the axial direction, and thus the magnetic field generating unit 56 is positioned with respect to the outer tube member 16 in the axial direction. As a result, in positioning the magnetic field generating unit 56 by the outer tube member 16 and the tubular cover member 46, the force acting on the magnetic field generating unit 56 is relieved by the first and second end portion elastic bodies 36 and 54, and the distortion of the magnetic field generating unit 56 is reduced. Further, since a contact reaction force exerted on the outer tube member 16 and the tubular cover member 46 is also reduced by the magnetic field generating unit 56 being sandwiched therebetween in the axial direction, the distortion of the outer tube member 16 and the tubular cover member 46 is also reduced.

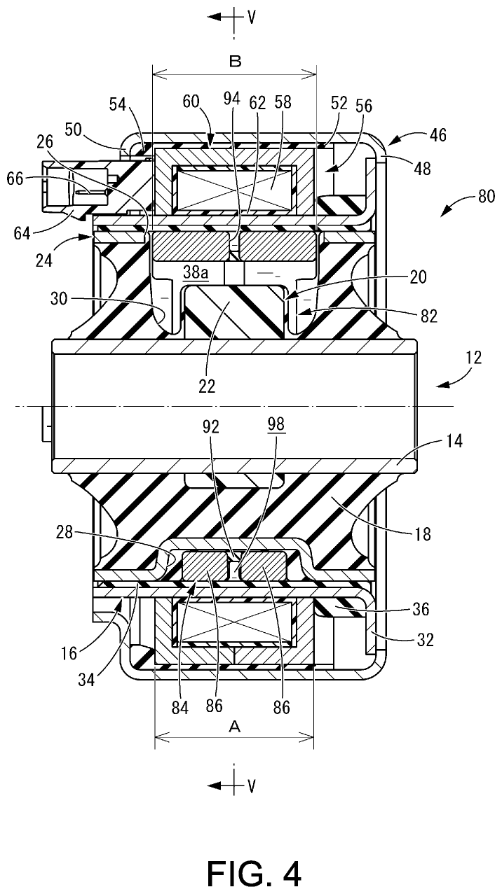

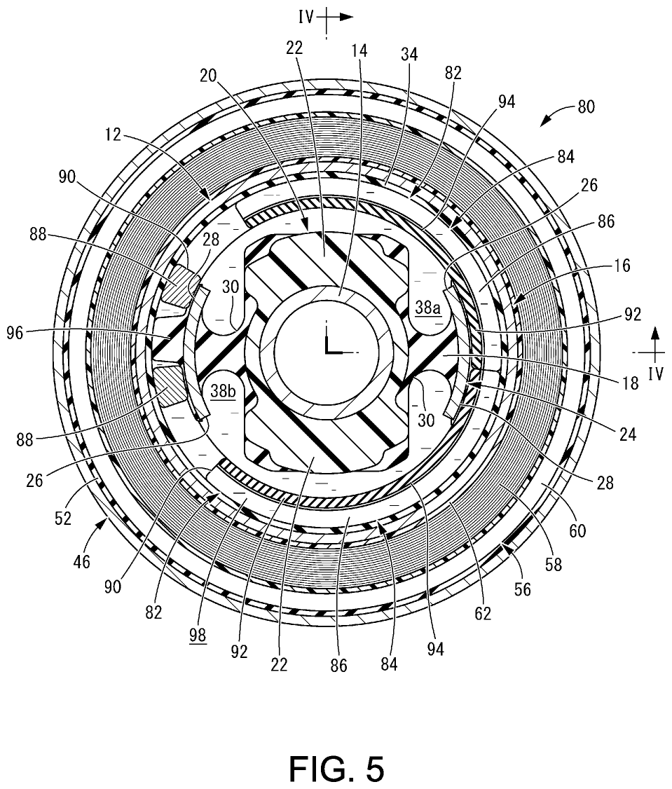

FIGS. 4 and 5 show an engine mount 80 for an automobile as a second embodiment of a fluid-filled type vibration isolating device having a structure according to the present invention. In the following description, the members and parts that are substantially the same as those of the other embodiments are designated by the same reference signs in the drawings, and the description thereof will be omitted.

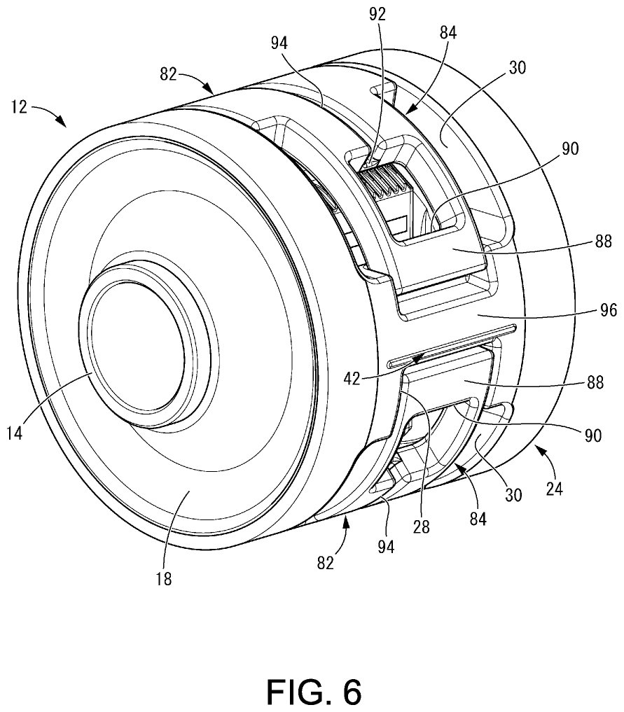

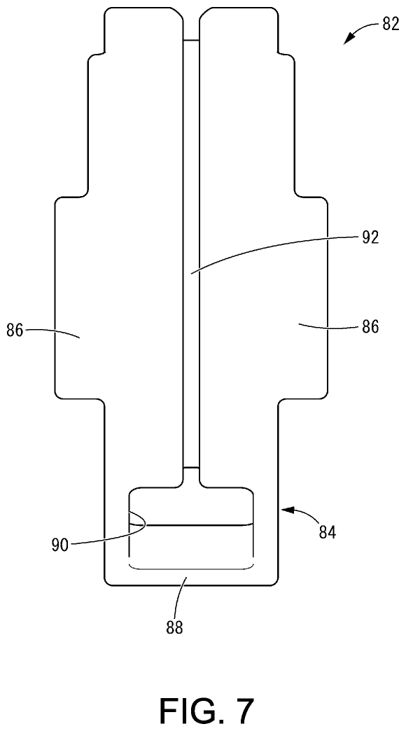

As shown in FIG. 6, the engine mount 80 includes an orifice member 82. The orifice member 82 has a semi-cylindrical shape as a whole, and as shown in FIG. 7, both end surfaces in the axial direction (the horizontal direction in FIG. 7) have a stepped shape, and thus the central portion in the circumferential direction is wider in the axial direction than both side portions in the circumferential direction. The orifice member 82 includes a magnetic flux concentrating member 84. The magnetic flux concentrating member 84 is formed of a ferromagnetic material such as iron and includes a set of magnetic flux guiding parts 86 and 86 arranged apart from each other in the axial direction and a connecting part 88 by which the magnetic flux guiding parts 86 and 86 are continuous with each other at one end portion in the circumferential direction. The magnetic flux guiding parts 86 and 86 have a plane-symmetrical shape with respect to a plane extending in the direction perpendicular to the axis and are arranged apart from each other in the axial direction with a predetermined gap. The magnetic flux guiding parts 86 and 86 have a substantially quadrangular cross section, and the facing surfaces thereof in the axial direction are flat surfaces extending in the direction perpendicular to the axis in the middle in the radial direction excluding rounded corners, and thus the axial separation distance therebetween is substantially constant in the middle in the radial direction. Further, the connecting part 88 has a plate shape and is provided with a communication hole 90 that penetrates it in a thickness direction. The magnetic flux guiding parts 86 and 86 do not necessarily have to be integrally continued and may be formed as, for example, components which are independent from each other to be connected to each other by a bottom rubber 92 which will be described later.

The orifice member 82 includes a bottom rubber 92. The bottom rubber 92 is arranged between the set of magnetic flux guiding parts 86 and 86 in the axial direction, extends in the circumferential direction, and is fixed to the inner circumferential portions of the magnetic flux guiding parts 86 and 86, whereby the magnetic flux guiding parts 86 and 86 are connected to each other. By providing the bottom rubber 92, a circumferential groove 94 that is open on the outer circumferential surface of the orifice member 82 and extends in the circumferential direction is formed between the magnetic flux guiding parts 86 and 86 of the orifice member 82 in the axial direction. In the circumferential groove 94, both side surfaces are formed with the magnetic flux guiding parts 86 and 86 having a ferromagnetic material, and a groove bottom surface is formed with the bottom rubber 92 of a non-magnetic material. In the circumferential groove 94, one end portion communicates with the communication hole 90, and the other end portion is open to the end surface of the orifice member 82 in the circumferential direction.

As shown in FIGS. 5 and 6, the orifice member 82 is arranged over the window part 26 of the intermediate sleeve 24 in the mount main body 12 in the circumferential direction. Two orifice members 82 and 82 are arranged to extend in the circumferential direction at an opening portion of each window part 26. The orifice members 82 and 82 may be separate components having different structures from each other, but in the present embodiment, they are common components and are attached to the mount main body 12 in different directions. Specifically, in the orifice members 82 and 82, the connecting parts 88 and 88 are inserted into one groove-shaped portion 28, and circumferential end portions on sides opposite to the connecting parts 88 and 88 are inserted into the other groove-shaped portion 28.

A partition rubber 96 protruding from the groove bottom surface of one groove-shaped portion 28 toward the outer periphery is arranged between the connecting parts 88 and 88 of the orifice members 82 and 82, and the connecting parts 88 and 88 are in contact with the partition rubber 96 from both sides in the circumferential direction. As a result, the orifice members 82 and 82 are positioned with respect to each other in the circumferential direction.

The circumferential end surfaces of the orifice members 82 and 82 are butted against each other in the circumferential direction at the other groove-shaped portion 28, and the circumferential grooves 94 and 94 of the two orifice members 82 and 82 are continuous in the circumferential direction. Further, the orifice member 82 is in contact with the axial inner surface of the window part 26 at the central portion in the circumferential direction in which the axial dimension is increased, and the orifice member 82 is positioned with respect to the intermediate sleeve 24 in the axial direction.

In the orifice member 82, both end portions in the circumferential direction are sandwiched and supported between the intermediate sleeve 24 and the outer tube member 16 in the radial direction by the outer tube member 16 being mounted on the intermediate sleeve 24. The outer circumferential surface of the orifice member 82 is fluid-tightly superposed on the inner circumferential surface of the outer tube member 16 via the seal rubber layer 34, and an opening of the circumferential groove 94 of the orifice member 82 is fluid-tightly covered with the outer tube member 16. As a result, an orifice passage 98 that causes the first and second fluid chambers 38a and 38b to communicate with each other through the communication holes 90 and 90 at both ends is provided, and the two fluid chambers 38 and 38 (the first and second fluid chambers 38a and 38b) communicate with each other through the orifice passage 98. The orifice passage 98 of the present embodiment extends across the openings of the window parts 26 and 26 in the circumferential direction and the length of the orifice passage 98 in the circumferential direction is longer than that of the orifice passage 40 of the first embodiment. Therefore, it is possible to favorably exhibit the vibration isolating effect by increasing the passage cross-sectional area of the orifice passage 98 or to set a resonance frequency of the fluid flowing through the orifice passage 98, in other words, a tuning frequency of the orifice passage 98 to a lower frequency.

As shown in FIG. 4, as in the first embodiment, the magnetic field generating unit 56 is arranged on the outer periphery of the outer tube member 16, and the magnetic field generating unit 56 is configured to exert a magnetic field on the magnetically functional fluid in the orifice passage 98 due to the energization to the coil 58. As in the first embodiment, the strength of the magnetic field exerted on the magnetically functional fluid in the orifice passage 98 is controlled by the control of the energization to the coil 58, and thus the viscosity of the magnetically functional fluid can be appropriately changed and the properties such as the spring and the damping of the engine mount 80 can be controlled.

Here, in the present embodiment, as shown in the upper half portion of FIG. 4, in the magnetic flux concentrating member 84 constituting both side wall portions of the orifice passage 98, the overall axial length B is equal to or larger than an axial length A of a portion which is open in the yoke member 60 (A≤B). Specifically, the axial length B of the central portion in the circumferential direction widened in the axial direction in the magnetic flux concentrating member 84 (the orifice member 82) is larger than the axial length A of the inner circumferential side opening of the yoke member 60.

As described above, in the magnetic flux concentrating member 84 constituting both side wall portions of the orifice passage 98, the overall axial length B may be equal to or larger than the axial length A on the open inner circumferential side of the yoke member 60 (A≤B), and the axial length B may be the same as the axial length A (A≤B). As a result, in the magnetic flux which is exerted from the magnetic field generating unit 56 through the yoke member 60, it is possible to more effectively suppress the magnetic flux leaking to the outside. As a result, it is possible to more efficiently exert the magnetic flux to the magnetic flux concentrating member 84 and the magnetically functional fluid in the orifice passage 98 whose both side wall portions are formed by the magnetic flux concentrating member 84. In the magnetic flux concentrating member, a portion in which the axial length of the whole (the whole including the left and right both side wall portions) is set to be equal to or larger than the axial length on the open inner circumferential side of the yoke member (the dimension between axial both sides of the inner circumferential end constituting the opening portion of the yoke member) may be partial of the magnetic flux concentrating member in the circumferential direction as in the present embodiment or may be the total length of the magnetic flux concentrating member in the circumferential direction.

Further, in the present embodiment, the length of the orifice passage 98 in the circumferential direction is long, and the magnetic field generated by the annular magnetic field generating unit 56 is exerted on the magnetically functional fluid in a wide range in the circumferential direction. Therefore, by controlling the viscosity of the magnetically functional fluid in the orifice passage 98, it is possible to change the properties of the engine mount 80 more significantly.

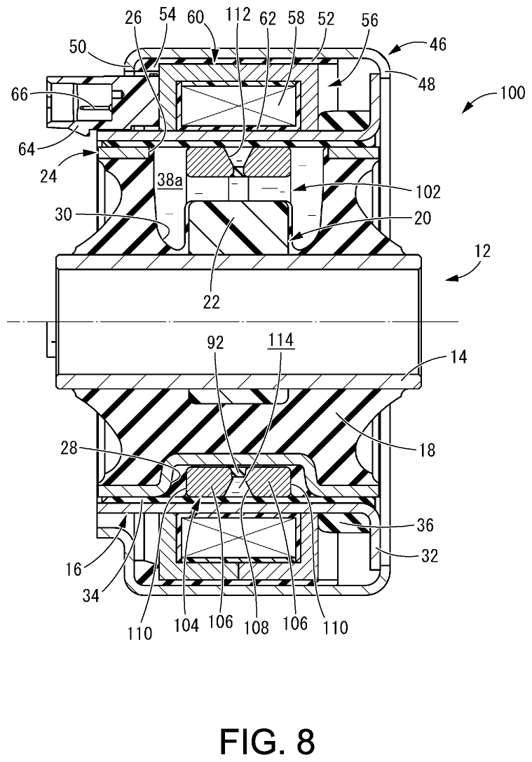

FIG. 8 shows an engine mount 100 for an automobile as a third embodiment of a fluid-filled type vibration isolating device having a structure according to the present invention. The engine mount 100 includes an orifice member 102.

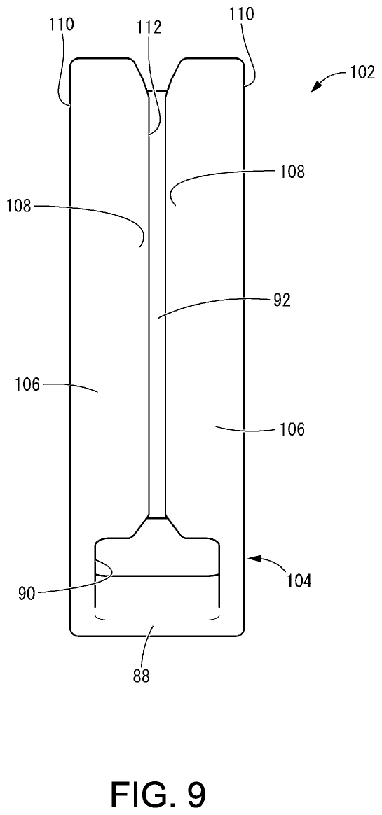

As shown in FIG. 9, the orifice member 102 has substantially the same structure as the orifice member 82 of the second embodiment and includes a magnetic flux concentrating member 104 and the bottom rubber 92. The magnetic flux concentrating member 104 integrally includes magnetic flux guiding parts 106 and 106 and the connecting part 88 by which the magnetic flux guiding parts 106 and 106 are continuous at the circumferential end portion.

The magnetic flux concentrating member 104 of the present embodiment has a different cross-sectional shape of the magnetic flux guiding part from that of the magnetic flux concentrating member 84 of the second embodiment. That is, as shown in FIG. 8, in the magnetic flux guiding parts 106 and 106 of the present embodiment, an inner side surface 108 in the axial direction, which is a facing surface in the axial direction, extends in the direction perpendicular to the axis at a fixed portion of the bottom rubber 92 and has an expanded shape which is inclined outward in the axial direction toward the outer periphery on the outer circumferential side from the bottom rubber 92. Further, an outer side surface 110 in the axial direction extends in the direction perpendicular to the axis. The inner side surface 108 and the outer side surface 110 in the axial direction are provided, and thus the magnetic flux guiding parts 106 and 106 have a cross-sectional shape in which axial dimensions on the outer circumferential side from the bottom rubber 92 are larger toward the inner periphery as shown in FIG. 8.

Further, the distance between the inner side surfaces 108 and 108 of the magnetic flux guiding parts 106 and 106 is smaller in the inner circumferential portion than in the outer circumferential portion on the outer circumferential side from the bottom rubber 92. As a result, the circumferential groove 112 having the magnetic flux guiding parts 106 and 106 as the side wall portions on both sides in the axial direction has a groove width dimension that becomes smaller toward the inner periphery. Therefore, in an orifice passage 114 of the present embodiment, the axial dimension of the passage cross section gradually decreases toward the inner periphery.

In such an engine mount 100 according to the present embodiment, when the coil 58 of the magnetic field generating unit 56 is energized to generate a magnetic field, the magnetic flux guided to the magnetic flux guiding parts 106 and 106 passes through the orifice passage 114 in the axial direction, and a magnetic field is exerted on the magnetically functional fluid in the orifice passage 114.

In the present embodiment, the axial separation distance between the magnetic flux guiding parts 106 and 106 is gradually reduced toward the inner circumferential side of the orifice passage 114. As a result, the magnetic flux is more easily guided to the inner circumferential portions of the magnetic flux guiding parts 106 and 106, and it is possible to exert a stronger magnetic field on the magnetically functional fluid flowing on the inner circumferential side of the orifice passage 114 extending in the circumferential direction.

In this way, by making the strength of the magnetic field exerted on the magnetically functional fluid in the orifice passage 114 various in the radial direction, for example, it is possible to control the flow state of the magnetically functional fluid in the orifice passage 114. Specifically, for example, in the outer circumferential portion of the orifice passage 114 in which a flow path of the magnetically functional fluid becomes longer, if the viscosity of the magnetically functional fluid is made smaller than that in the inner circumferential portion, it can also be expected to have the effect of suppressing the occurrence of turbulent flow due to the difference in the flow path in the orifice passage 114.

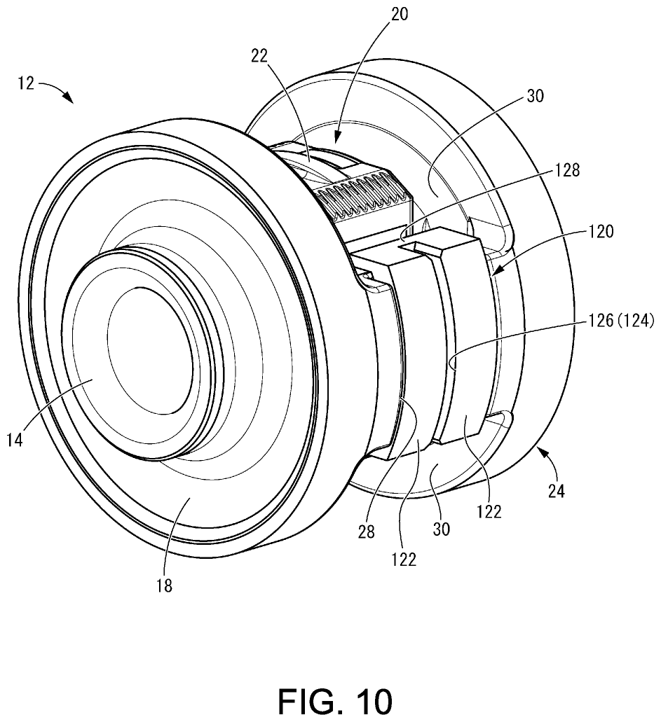

FIG. 10 shows a mount main body 12 and a magnetic flux concentrating member 120 constituting an engine mount for an automobile as a fourth embodiment of a fluid-filled type vibration isolating device having a structure according to the present invention. In the first embodiment, a set of magnetic flux concentrating members 42 and 42 are disposed inside the groove-shaped portion 28 to be separated from each other in the axial direction and face each other, and the orifice passage 40 extending in the circumferential direction is formed between these magnetic flux concentrating members 42 and 42, but the magnetic flux concentrating member 120 of the present embodiment has a shape in which these magnetic flux concentrating members 42 and 42 are integrally formed. In the present embodiment, since the outer tube member 16, the tubular cover member 46, and the magnetic field generating unit 56 are the same as those in the above embodiment, the illustration is omitted, and in the following description, the magnetic flux concentrating member 120, which is a difference from the above embodiment, will be mainly described.

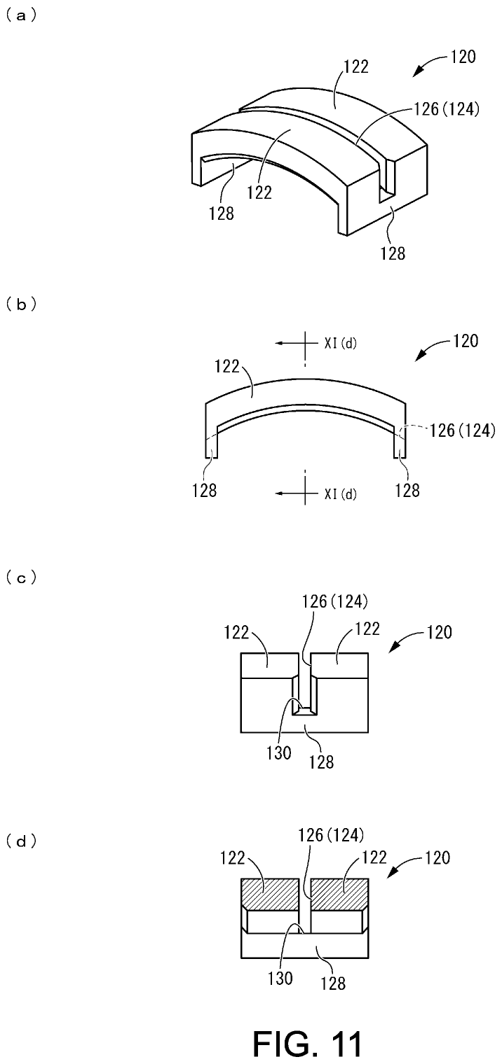

That is, as shown in FIG. 11, the magnetic flux concentrating member 120 of the present embodiment has both side facing wall portions 122 and 122 which are disposed to face each other on both sides in the axial direction of the mount central axis. A circumferential groove 126 that forms an orifice passage 124 by extending in the circumferential direction and by being covered with the outer tube member 16 at an outer circumferential side is formed between the both side facing wall portions 122 and 122. These both side facing wall portions 122 and 122 are continuous partially in a length direction of the orifice passage 124 (the circumferential direction of the both side facing wall portions 122 and 122), for example, on at least one end portion side of the orifice passage 124 in the longitudinal direction. In the present embodiment, the both side facing wall portions 122 and 122 are continuous at both end portions of the orifice passage 124 in the length direction, and continuous portions 128 and 128 of the both side facing wall portions 122 and 122 are provided at a position deviated to the inner circumferential side (an inward side in the radial direction) from the orifice passage 124. In the present embodiment, the outer tube member 16 and the like are omitted in the drawing as described above to show the magnetic flux concentrating member 120 which is a characteristic portion in an easy-to-understand manner, but the orifice passage 124 and the like are shown as one on which the outer tube member 16 is mounted as in the first embodiment.

In short, the both end portions of the both side facing wall portions 122 and 122 in the circumferential direction are provided with portions extending in the inner circumferential side (an inward side in the radial direction), and the extending portions are integrated and connected with each other to form the continuous portions 128 and 128. As a result, the circumferential groove 126 is formed over the entire length of the magnetic flux concentrating member 120 in the circumferential direction and is open outward in the circumferential direction. In a bottom portion of the circumferential groove 126, the both end portions in the circumferential direction are continuous by continuous portions 128 and 128, but the intermediate portion in the circumferential direction is provided with a through hole 130 that penetrates it in a thickness direction of the magnetic flux concentrating member 120 (in a radial direction of the mount main body 12).

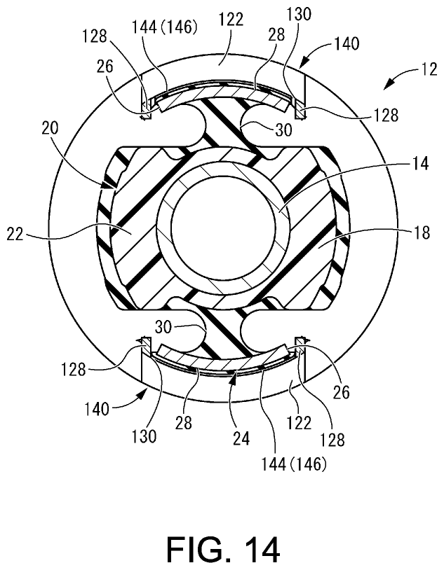

The magnetic flux concentrating member 120 is assembled on both sides in the radial direction with respect to the mount main body 12 and is fixed thereto as necessary. That is, the magnetic flux concentrating member 120 is fitted into the groove-shaped portion 28 of the mount main body 12 from the outer circumferential side, and the continuous portions 128 and 128 protruding from the magnetic flux concentrating member 120 to the inner circumferential side enter the inner circumferential side through the window parts 26 and 26 in the intermediate sleeve 24 (see FIG. 14 which will be described later). Further, the outer tube member 16 having the seal rubber layer 34 on the inner circumferential side is assembled on the outer circumferential side of the intermediate sleeve 24. As a result, the through hole 130, which is the inner circumferential side opening of the circumferential groove 126, is fluid-tightly covered with the main body rubber elastic body 18 fixed to the outer circumferential surface of the intermediate sleeve 24 in the groove-shaped portion 28, and the outer circumferential side opening of the circumferential groove 126 is fluid-tightly covered with the seal rubber layer 34.

As a result, in the engine mount of the present embodiment, the orifice passages 124 and 124 are formed on both sides in the radial direction, and the first and second fluid chambers 38a and 38b communicate with each other in the circumferential direction by the orifice passages 124 and 124. That is, in the present embodiment, the both side facing wall portions 122 and 122 are disposed to face each other on both sides of the orifice passages 124 and 124 in a width direction. Further, the orifice passages 124 and 124 cause the first fluid chamber 38a and the second fluid chamber 38b to communicate with each other in parallel on both sides in the radial direction. Further, in the present embodiment, since the same magnetic flux concentrating members 120 and 120 are assembled on both sides of the mount main body 12 in the radial direction, the orifice passages 124 and 124 are formed with the same passage cross-sectional area and passage length.

The same effect as that of the above embodiment can also be exhibited in the engine mount including the magnetic flux concentrating member 120 of the present embodiment. In particular, in the present embodiment, since the magnetic flux concentrating member 120 is constituted by one member, the number of components can be reduced and the structure of the mount can be simplified. Further, since the continuous portions 128 and 128 by which the both side facing wall portions 122 and 122 are continuous in the axial direction are provided at positions deviated from the orifice passage 124 to the inner circumferential side, it is possible to reduce the possibility that the fluid flowing through the orifice passage 124 hits the continuous portions 128 and 128 or to concentrate the magnetic flux.

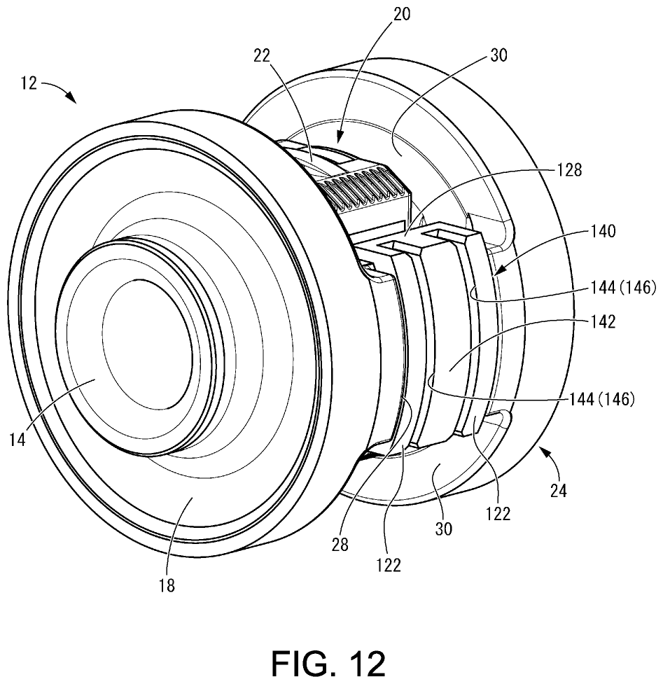

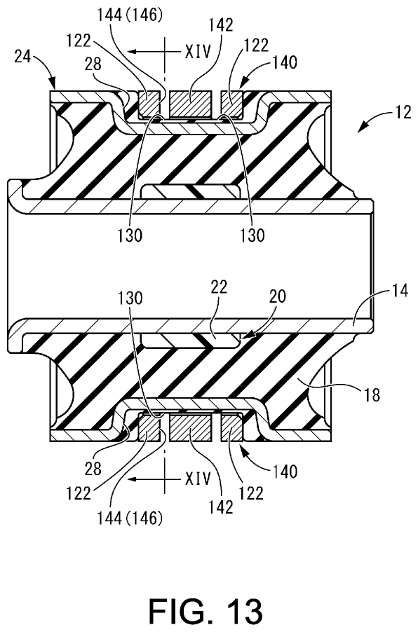

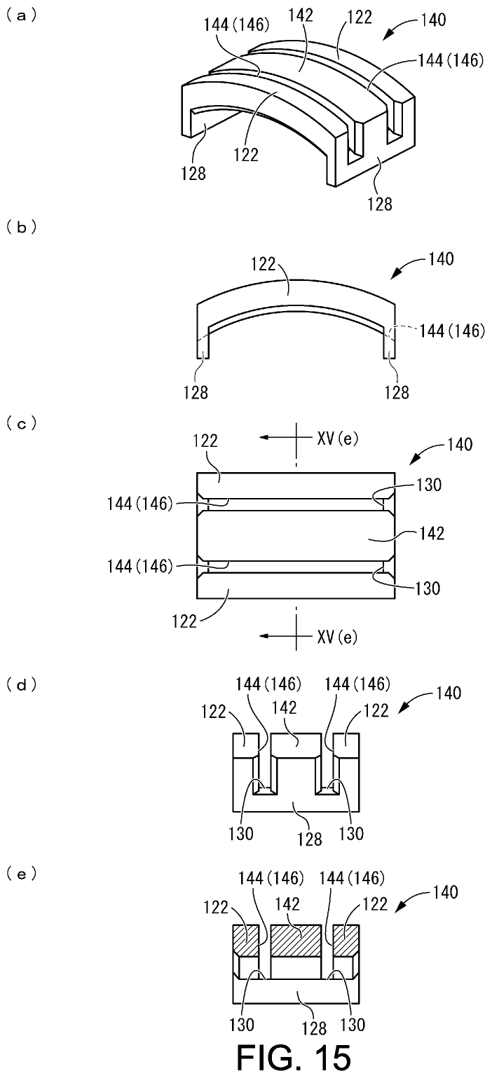

FIGS. 12 to 14 show a mount main body 12 and a magnetic flux concentrating member 140 constituting an engine mount for an automobile as a fifth embodiment of a fluid-filled type vibration isolating device having a structure according to the present invention. The basic structure of the magnetic flux concentrating member 140 of the present embodiment is the same as that of the magnetic flux concentrating member 120 of the fourth embodiment, but, as shown in FIG. 15, the magnetic flux concentrating member 140 has a central wall portion 142 at the center in the axial direction in addition to the both side facing wall portions 122 and 122 provided on axial both sides of the mount in the axial direction. The central wall portion 142 extends in the circumferential direction with a certain width dimension (a horizontal dimension in FIG. 13) and expands in parallel to the both side facing wall portions 122 and 122 on both sides in the axial direction. As a result, the magnetic flux concentrating member 140 of the present embodiment is provided with two circumferential grooves 144 and 144 extending in parallel to each other. Further, since the magnetic flux concentrating member 140 is provided on both sides of the mount main body 12 in the radial direction, the engine mount of the present embodiment is provided with a total of four circumferential grooves 144.

The through holes 130 and 130, which are the inner circumferential side openings of the circumferential grooves 144 and 144 in each magnetic flux concentrating member 140, are fluid-tightly covered with the main body rubber elastic body 18 fixed to the outer circumferential surface of the intermediate sleeve 24 in the groove-shaped portion 28, and the outer circumferential side openings of the circumferential grooves 144 and 144 are fluid-tightly covered with the seal rubber layer 34, whereby orifice passages 146 and 146 that cause the first fluid chamber 38a and the second fluid chamber 38b to communicate with each other are formed. That is, in the present embodiment, each orifice passage 146 has the central wall portion 142 shared by either one of the both side facing wall portions 122 and 122 on both sides in the width direction. In other words, the magnetic flux concentrating member 140 is provided on the wall portion of each of the orifice passages 146 and 146. Further, the engine mount of the present embodiment is provided with a total of four orifice passages 146, and these four orifice passages 146 cause the first fluid chamber 38a and the second fluid chamber 38b to communicate with each other in parallel in the radial direction and the axial direction.

In particular, in the present embodiment, the passage cross-sectional areas of the orifice passages 146 and 146 in each magnetic flux concentrating member 140 are equal. Further, since the continuous portions 128 and 128 by which the both side facing wall portions 122 and 122 are continuous in the axial direction are provided at positions deviated from the orifice passages 146 and 146 to the inner circumferential side, the orifice passages 146 and 146 are formed over the entire length of the magnetic flux concentrating member 140 in the circumferential direction, and the passage lengths of the orifice passages 146 and 146 are equal. As a result, tuning frequencies (liquid column resonance frequencies) of the two orifice passages 146 and 146 are also equal. Fluid flow is generated in each of the orifice passages 146 and 146 under substantially the same condition, and the two orifice passages 146 and 146 act as one orifice passage having a substantially combined large cross-sectional area.

The same effect as that of the above embodiment can also be exhibited in the engine mount including the magnetic flux concentrating member 140 of the present embodiment. In particular, in the present embodiment, since a plurality of orifice passages 146 is provided, a sufficiently large passage cross-sectional area is secured in the entire orifice passage, and it is possible to stably generate the fluid flow between the first fluid chamber 38a and the second fluid chamber 38b. Since the passage cross-sectional areas and passage lengths of the orifice passages 146 and 146 are equal, it is easy to tune the orifice passage having a large passage cross-sectional area as a whole, and a desired vibration isolating effect can be favorably exhibited.

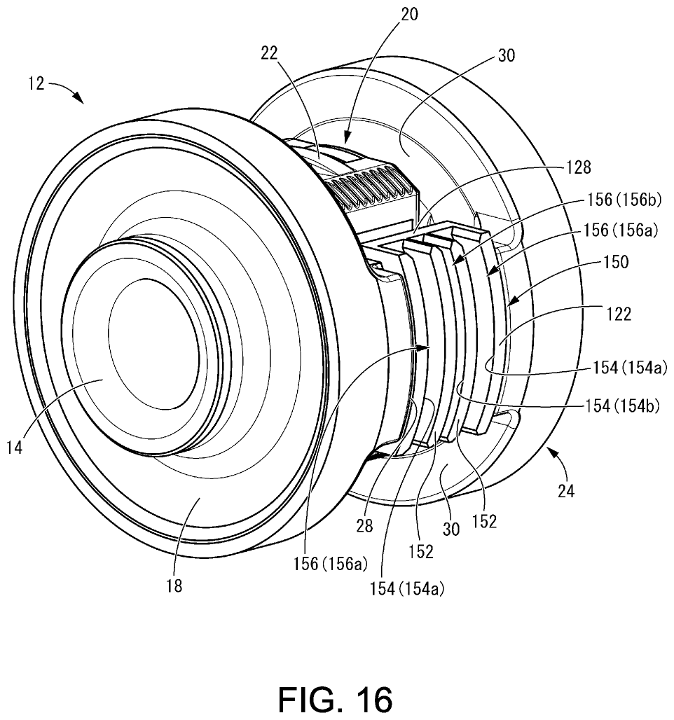

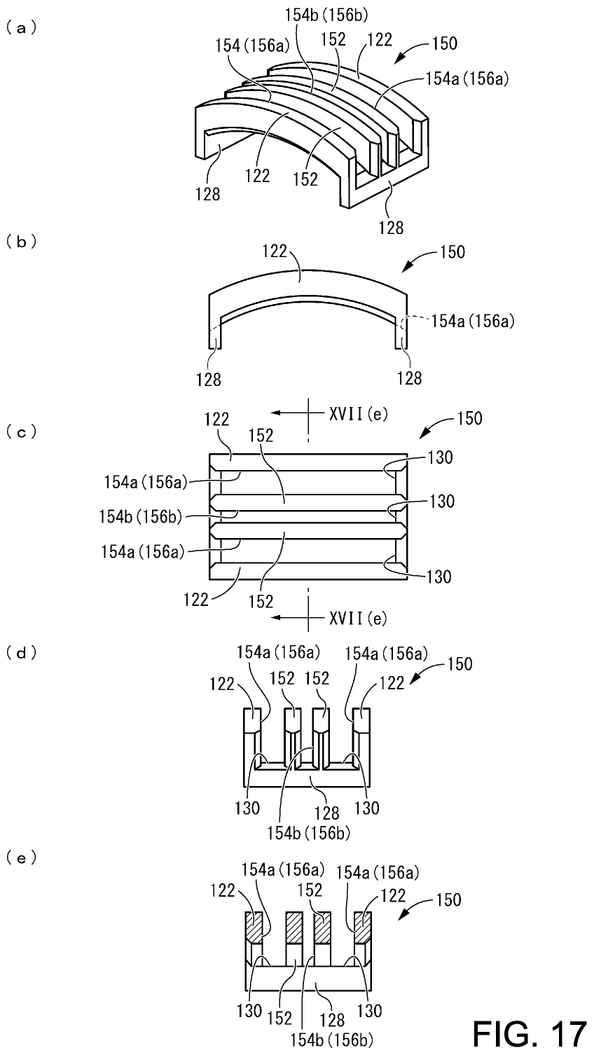

FIG. 16 shows a mount main body 12 and a magnetic flux concentrating member 150 constituting an engine mount for an automobile as a sixth embodiment of a fluid-filled type vibration isolating device having a structure according to the present invention. The basic structure of the magnetic flux concentrating member 150 of the present embodiment is the same as that of the magnetic flux concentrating member 140 of the fifth embodiment, but, as shown in FIG. 17, the magnetic flux concentrating member 150 has two intermediate wall portions 152 and 152, which are separated from each other in the axial direction, provided in an intermediate portion in the axial direction in addition to the both side facing wall portions 122 and 122 provided on axial both sides of the mount in the axial direction.

The intermediate wall portion 152 extends in the circumferential direction with a certain width dimension (a vertical dimension in (c) of FIG. 17), and the both side facing wall portions 122 and 122 on both sides in the axial direction and the intermediate wall portions 152 and 152 expand to be separated from each other in the axial direction and in parallel to each other. As a result, the magnetic flux concentrating member 150 of the present embodiment is provided with three circumferential grooves 154, 154, and 154 extending in parallel to each other. Further, since the magnetic flux concentrating member 150 is provided on both sides of the mount main body 12 in the radial direction, the engine mount of the present embodiment is provided with a total of six circumferential grooves 154 such that the circumferential grooves 154 extend in the circumferential direction with a substantially constant cross-sectional shape. In particular, in the present embodiment, although a depth dimension (a radial dimension) of each circumferential groove 154 is substantially the same, the circumferential grooves 154 and 154 on both sides in the axial direction have a groove width dimension wider than that of the circumferential groove 154 at the center in the axial direction, the circumferential grooves 154 and 154 on both sides in the axial direction are wide circumferential grooves 154a and 154a, and the circumferential groove 154 at the center in the axial direction is a narrow circumferential groove 154b.

As in the fifth embodiment, the inner circumferential side opening of the circumferential groove 154 is fluid-tightly covered with the main body rubber elastic body 18, and the outer circumferential side opening of the circumferential groove 154 is fluid-tightly covered with the seal rubber layer 34, whereby three orifice passages 156, 156, and 156 that cause the first fluid chamber 38a and the second fluid chamber 38b to communicate with each other are formed. In the present embodiment, the orifice passages 156 and 156 on both sides in the axial direction are wide orifice passages 156a and 156a, and the orifice passage 156 at the center in the axial direction is a narrow orifice passage 156b. In short, the wide orifice passages 156a and 156a have one of the both side facing wall portions 122 and 122 on both sides in the width direction and one of the intermediate wall portions 152, and the narrow orifice passage 156b has intermediate wall portions 152 and 152 on both sides in the width direction. Further, the engine mount of the present embodiment is provided with a total of six orifice passages 156, and these six orifice passages 156 cause the first fluid chamber 38a and the second fluid chamber 38b to communicate with each other in parallel in the radial direction and the axial direction.

The magnetic flux concentrating member 150 of the present embodiment has three orifice passages 156, 156, and 156, and, among them, one orifice passage 156 (the narrow orifice passage 156b) has a passage cross-sectional area different from those of the remaining two orifice passages 156 and 156 (the wide orifice passages 156a and 156a). Further, the passage cross-sectional areas of the wide orifice passages 156a and 156a are equal. Further, the orifice passages 156 are formed over the entire length of the magnetic flux concentrating member 150 in the circumferential direction, and the passage lengths of the orifice passages 156 are equal. As a result, between the wide orifice passages 156a and 156a and the narrow orifice passage 156b, a ratio (A/L) of the passage cross-sectional area to the passage length is different, and the fluid flow properties and the tuning frequency (the liquid column resonance frequency) are different.

The same effect as that of the above embodiment can also be exhibited in the engine mount including the magnetic flux concentrating member 150 of the present embodiment. For example, depending on the input vibration, based on the flow action of the fluid flowing through all the orifice passages 156a and 156b, it is possible to realize low dynamic spring properties by the action of reducing the pressure fluctuation of each of the fluid chambers 38a and 38b. Further, depending on the input vibration, based on the flow action of the fluid flowing through all the orifice passages 156a and 156b, it is conceivable to improve the vibration isolating properties by the action of high damping. In particular, in the present embodiment, since the wide orifice passage 156a and the narrow orifice passage 156b show different fluid flow properties, it is also possible to exhibit the vibration isolating effect of each orifice passage 156 with respect to different input vibrations in a plurality of frequency ranges, for example. At that time, for example, it is also conceivable to adjust the frequency range in which predetermined vibration isolating properties are exhibited by adjusting a feeding voltage to the coil 58 of the magnetic field generating unit 56 or turning the voltage on/off, to substantially shut off the narrow orifice passage 156b while maintaining the fluid flow performed through the wide orifice passage 156a, or the like.

It is also possible to set different cross-sectional areas or different passage lengths for the two wide orifice passages 156a and 156a. Thereby, it is possible to set an orifice passage in which three or more different fluid flow states are expressed.

Although the embodiments of the present invention have been described in detail above, the present invention is not limited by the specific description thereof. For example, the vibration isolating device according to the present invention may be provided with a plurality of orifice passages as in some of the above-described embodiments, and, in this case, it is sufficient that a magnetic field is exerted on the magnetically functional fluid from the magnetic field generating unit in at least one orifice passage.

The orifice passage 40 of the first embodiment extends in the circumferential direction as a whole, but the orifice passage may extend partially in the axial direction or the radial direction, for example. In this case, it is desirable that the magnetic field of the magnetic field generating unit be exerted on the magnetically functional fluid at a portion of the orifice passage that extends in the circumferential direction.

For example, the magnetic flux concentrating member 42 in the first embodiment does not necessarily have to be provided to form the both side wall portions of the orifice passage 40 in the axial direction. Specifically, for example, the side wall portion on one side of the orifice passage 40 in the axial direction may be formed with the magnetic flux concentrating member 42, and the other side wall portion of the orifice passage 40 may be formed with a non-magnetic material. Further, in a case in which a plurality of orifice passages is provided, an orifice passage in which the magnetic flux concentrating member is not provided on the wall portion may be included. That is, it is sufficient that the magnetic flux concentrating member is provided on the wall portion of at least one orifice passage, and even if there is an orifice passage that is not affected by the change in magnetic flux due to the magnetic flux generating unit, the magnetic flux is exerted on the magnetically functional fluid in at least one orifice passage through the magnetic flux concentrating member from the magnetic field generating unit, and the fluid flow properties in the orifice passage can be controlled, and thus it is possible to realize characteristic switching of the vibration isolating performance depending on the flow action of the fluid.

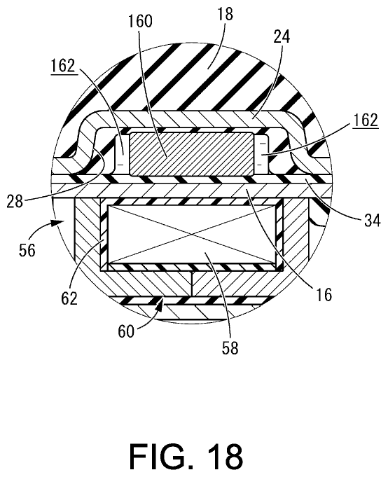

Further, for example, as in a magnetic flux concentrating member 160 shown in FIG. 18, the magnetic flux concentrating member 160 may be arranged in the axially intermediate portion of a region for forming orifice passages 162, and the orifice passages 162 may be formed on both sides in the axial direction with respect to the magnetic flux concentrating member 160. In the magnetic flux concentrating member 160 shown in FIG. 18, the axial dimension of the inner circumferential portion may be larger than that of the outer circumferential portion by making both sides in the axial direction inclined surfaces, and thus it is possible to make the magnetic field acting on the inner circumferential side of the orifice passage 162 stronger than that acting on the outer circumferential side. Further, the orifice passages 162 on both sides in the axial direction may have the same passage cross-sectional area and passage length, or may have different passage cross-sectional areas and passage lengths from each other. Further, it is also possible to arrange the magnetic flux concentrating member partially in the length direction of the orifice passage without disposing the magnetic flux concentrating member over the entire length of the orifice passage in the length direction.

In the region for forming the orifice passage, it is also possible to provide both of the magnetic flux concentrating members 42 and 42 provided at both end portions in the axial direction and the magnetic flux concentrating member 160 provided at the intermediate portion in the axial direction together, and thus it is possible to more effectively realize the concentrating of the magnetic flux. Further, the magnetic flux concentrating member does not necessarily have to be provided over the entire orifice passage in the radial direction and may be smaller than the orifice passage in the radial direction. That is, the magnetic flux concentrating member may be provided, for example, to protrude into the orifice passage from the wall portion on the inner circumferential side or the outer circumferential side of the orifice passage in the middle of the orifice passage in the axial direction. In short, the magnetic flux concentrating member may be any as long as it constitutes a magnetic circuit arranged around the coil and guides the magnetic flux to pass through the orifice passage, and the disposition or the like thereof can be appropriately changed.

In the above embodiment, the coil 58 is arranged over the entire circumference of the outer tube member 16 in externally fitted state, but the coil 58 does not necessarily have to be arranged coaxially with the outer tube member 16. Specifically, for example, the coil may be arranged partially in the circumferential direction toward the outer circumferential side of the outer tube member such that the central axis of the coil is located on the outer periphery of the outer tube member. According to this, when the coil is energized, the position of action of the magnetic field on the magnetically functional fluid can be limited in the circumferential direction of the outer tube member.

In the above embodiment, two fluid chambers 38 and 38 (the first and second fluid chambers 38a and 38b) are both pressure receiving chambers that cause internal pressure fluctuation at the time of vibration input, however, for example, one fluid chamber may be an equilibrium chamber in which a part of the wall portion is made of a flexible film. The fluid chamber is not limited to two, and a structure including three or more fluid chambers may be employed. For example, at least one of the first fluid chamber and the second fluid chamber may be constituted by of a plurality of fluid chambers divided in the circumferential direction. In a specific example, two second fluid chambers 38b1 and 38b2 divided in the circumferential direction may be disposed to face one first fluid chamber 38a in the direction perpendicular to the axis, and at least one first orifice passage that causes the first fluid chamber 38a to communicate with the one second fluid chamber 38b1 may be formed on one side of the first fluid chamber 38a in the circumferential direction, and further, at least one second orifice passage that causes the first fluid chamber 38a to communicate with the other second fluid chamber 38b2 may be formed on the other side of the first fluid chamber 38a in the circumferential direction.

In some of the above-described embodiments, the orifice passages are provided in parallel, but “in parallel” means “not in series” and does not have to be parallel in shape. That is, for example, in the fifth and sixth embodiments, a plurality of orifice passages 146 or orifice passages 156 is disposed in parallel, but even if they are provided to be inclined by different angles with respect to the circumferential direction of the mount main body or are provided in different forms such as meandering, it is understood that they are disposed in parallel. Therefore, the plurality of orifice passages that causes the first fluid chamber and the second fluid chamber to communicate with each other in parallel may cause the first fluid chamber and the second fluid chamber to communicate with each other at different positions and in different shapes.

Further, in a case in which a plurality of orifice passages having different passage cross-sectional areas is provided, for example, the wall portion of the orifice passage having a large cross-sectional area and a small fluid flow resistance is formed with a magnetic flux concentrating member, and, on the other hand, the magnetic flux is not sufficiently exerted on the orifice passage having a small cross-sectional area, whereby it is possible to exert the magnetic flux due to an operation of the magnetic field generating unit only to the magnetically functional fluid in the orifice passage having a large cross-sectional area. As a result, the flow state of the orifice passage having a small fluid flow resistance is controlled, and the orifice passage having a small cross-sectional area and a large fluid flow resistance is maintained in a constantly communicating state, whereby it is possible to realize the control with the overall vibration isolating performance.

In the fourth to sixth embodiments, the magnetic flux concentrating members 120, 140, and 150 are each provided with the through hole 130 in an intermediate portion in the circumferential direction without a bottom wall portion and are each provided with the continuous portions 128 and 128 at both ends in the circumferential direction, but, for example, by employing a ferromagnetic resin mixed with a magnetic material (powder, and the like) for the wall portions (the both sides facing wall portions, the central wall portion, the intermediate wall portion) of the magnetic flux concentrating member and by employing a non-magnetic resin for a bottom wall portion, it is possible to realize the circumferential groove 126 or the like extending in the circumferential direction with a recessed groove cross-sectional shape having a bottom wall portion without the through hole 130, and it is also possible to form the magnetic flux concentrating member as an integrally formed product of a synthetic resin.

Other configurations According to a first aspect, there is provided a fluid-filled type vibration isolating device in which an inner shaft member and an outer tube member are connected to each other with a main body rubber elastic body and a plurality of fluid chambers filled with a fluid is provided to be separated from each other in a circumferential direction and communicates with each other through an orifice passage, wherein the fluid is a magnetically functional fluid, wherein the outer tube member is a non-magnetic material, wherein a tubular cover member is disposed to be separated toward an outer circumferential side from the outer tube member, wherein a magnetic field generating unit that exerts a magnetic field on the magnetically functional fluid is assembled between the outer tube member and the tubular cover member, and wherein one side member and another side member to be connected to each other in a vibration isolating manner are configured to be attached to the inner shaft member and the tubular cover member.

According to the fluid-filled type vibration isolating device having the structure according to the present aspect, the fluid which fills the fluid chamber is a magnetically functional fluid, and the viscosity changes depending on the magnetic field exerted from the magnetic field generating unit. Therefore, by controlling the magnetic field exerted from the magnetic field generating unit according to input vibration, it is possible to change properties of the vibration isolating device according to the input vibration and to obtain excellent vibration isolating performance.

Since the magnetic field can be exerted on the magnetically functional fluid which fills the inside of the vibration isolating device from the outside of a region filled with the fluid, the magnetic field generating unit that exerts the magnetic field on the magnetically functional fluid is provided on the outer circumferential side of the outer tube member and is not exposed in the region filled with the fluid. Therefore, in the vibration isolating device, a portion which is filled with the fluid and a portion where a magnetic field is generated are separated from each other, and it is possible to simplify the structure as compared with a case in which the magnetic field generating unit is built in. In particular, since the magnetic field generating unit that generates a magnetic field is provided on the outer circumferential side of the outer tube member, it is possible to easily provide a wiring or the like for energizing the magnetic field generating unit.

The tubular cover member which is attached to a member to be connected in a vibration isolating manner is arranged on the outer circumferential side of the outer tube member, and the magnetic field generating unit is assembled between the outer tube member and the tubular cover member. Therefore, even if the magnetic field generating unit is arranged on the outer circumferential side of the outer tube member, it is possible to attach the vibration isolating device to the member to be connected in a vibration isolating manner by the tubular cover member. Further, since the magnetic field generating unit is protected by the tubular cover member, damage to the magnetic field generating unit is avoided.

According to a second aspect, in the fluid-filled type vibration isolating device of the first aspect, the tubular cover member is a non-magnetic material.

According to the fluid-filled type vibration isolating device having the structure according to the present aspect, the escape of the magnetic field generated by the magnetic field generating unit to the outer circumferential side is reduced by the tubular cover member formed of a non-magnetic material, and thus it is possible to efficiently exert the magnetic flux to the magnetically functional fluid on the inner circumferential side from the magnetic field generating unit.

According to a third aspect, in the fluid-filled type vibration isolating device of the first or second aspect, an outer circumferential surface of the magnetic field generating unit is superposed on the tubular cover member via an outer circumferential elastic layer, and the magnetic field generating unit is sandwiched between the outer tube member and the tubular cover member in a direction perpendicular to an axis.

According to the fluid-filled type vibration isolating device having the structure according to the present aspect, the outer circumferential elastic layer is interposed between the magnetic field generating unit and the tubular cover member. Therefore, a force acting on the outer tube member, the tubular cover member, and the magnetic field generating unit is relieved as compared with a case in which the magnetic field generating unit is sandwiched between the outer tube member and the tubular cover member without the elastic layer, and the distortion of the outer tube member, the tubular cover member, and the magnetic field generating unit is reduced.

According to a fourth aspect, in the fluid-filled type vibration isolating device of any one of the first to third aspects, an end portion elastic body is arranged on at least one side of the magnetic field generating unit in an axial direction, and the magnetic field generating unit is positioned in the axial direction by the outer tube member and the tubular cover member via the end portion elastic body.

According to the fluid-filled type vibration isolating device having the structure according to the present aspect, the end portion elastic body is interposed between the magnetic field generating unit and at least one of the outer tube member and the tubular cover member in the axial direction. Therefore, a force acting on the outer tube member, the tubular cover member, and the magnetic field generating unit is relieved as compared with a case in which the magnetic field generating unit is directly positioned in the axial direction with respect to the outer tube member and the tubular cover member, and the distortion of the outer tube member, the tubular cover member, and the magnetic field generating unit is reduced.

According to a fifth aspect, there is provided a fluid-filled type vibration isolating device in which an inner shaft member and an outer tube member are connected to each other with a main body rubber elastic body and a plurality of fluid chambers filled with a fluid is provided to be separated from each other in a circumferential direction and communicates with each other through an orifice passage, wherein the fluid is a magnetically functional fluid, wherein the outer tube member is a non-magnetic material, wherein a magnetic field generating unit that exerts a magnetic field on the magnetically functional fluid is mounted on an outer circumferential side of the outer tube member, and wherein a magnetic flux concentrating member formed of a ferromagnetic material is disposed on a wall portion of the orifice passage.

According to the fluid-filled type vibration isolating device having the structure according to the present aspect, the fluid which fills the fluid chamber is a magnetically functional fluid, and the viscosity changes depending on the magnetic field exerted from the magnetic field generating unit. Therefore, by controlling the magnetic field exerted from the magnetic field generating unit according to input vibration, it is possible to change properties of the vibration isolating device according to the input vibration and to obtain excellent vibration isolating performance.

The magnetic field generating unit that exerts a magnetic field on the magnetically functional fluid is provided on the outer circumferential side of the outer tube member and is not arranged in the fluid chamber. Therefore, in the vibration isolating device, a portion which is filled with the fluid and a portion where a magnetic field is generated are separated from each other, and it is possible to simplify the structure. In particular, since the magnetic field generating unit that generates a magnetic field is provided on the outer circumferential side of the outer tube member, it is possible to easily provide a wiring or the like for energizing the magnetic field generating unit.

Since the magnetic flux concentrating member is disposed on the wall portion of the orifice passage, the magnetic flux line in the magnetic field exerted from the magnetic field generating unit disposed on the outer circumferential side of the outer tube member is efficiently guided to the orifice passage by the magnetic flux concentrating member. As a result, a stronger magnetic field is exerted on the magnetically functional fluid in the orifice passage, and the viscosity of the magnetically functional fluid can be efficiently controlled by the magnetic field generating unit arranged on the outside.

According to a sixth aspect, in the fluid-filled type vibration isolating device of the fifth aspect, in a portion of the orifice passage that extends in the circumferential direction, the magnetic flux concentrating member is disposed on each of side wall portions on both sides facing each other in an axial direction.

According to the fluid-filled type vibration isolating device having the structure according to the present aspect, in a portion of the orifice passage that extends in the circumferential direction, the magnetic flux is effectively guided to the orifice passage by the magnetic flux concentrating members provided on both sides of the orifice passage in the axial direction. Therefore, the magnetic field generated by the magnetic field generating unit is more strongly exerted on the magnetically functional fluid in the orifice passage, and the viscosity of the magnetically functional fluid can be efficiently controlled in the portion of the orifice passage that extends in the circumferential direction.

According to a seventh aspect, in the fluid-filled type vibration isolating device of the sixth aspect, the magnetic flux concentrating member is disposed in a portion of the orifice passage that extends in the circumferential direction, and in the magnetic flux concentrating member, an axial dimension in an inner circumferential portion is larger than that in an outer circumferential portion.

According to the fluid-filled type vibration isolating device having the structure according to the present aspect, in the inner circumferential portion of the orifice passage in which the flow path of the magnetically functional fluid is shorter than that of the outer circumferential portion, the axial dimension of the magnetic flux concentrating member is large, and thus the magnetic flux is easily guided to the inner circumferential portion. Then, the magnetic field exerted from the magnetic field generating unit acts more strongly on the inner circumferential side of the orifice passage than on the outer circumferential side, the viscosity of the magnetically functional fluid is significantly increased on the inner circumferential side compared to the outer circumferential side, and the flow resistance of the fluid flowing on the inner circumferential side becomes larger than the flow resistance of the fluid flowing on the outer circumferential side. Therefore, the flow velocity of the fluid flowing on the inner circumferential side in which the flow path is short becomes smaller than the flow velocity on the outer circumferential side, and the occurrence of turbulent flow due to the difference in the flow path is prevented.

According to an eighth aspect, in the fluid-filled type vibration isolating device of any one of the fifth to seventh aspects, as the plurality of fluid chambers, a first fluid chamber and a second fluid chamber are provided, as the orifice passage, a plurality of orifice passages through which the first fluid chamber and the second fluid chamber communicate with each other in parallel is provided, and the magnetic flux concentrating member formed of a ferromagnetic material is disposed on a wall portion in at least one of the orifice passages.

According to the fluid-filled type vibration isolating device having the structure according to the present aspect, it is possible to increase the degree of freedom in designing the total cross-sectional area of the orifice passage by providing a plurality of orifice passages in parallel. For example, it is also possible to perform tuning to set the passage cross-sectional area large in the entire orifice passage while securing a magnetic field action on the magnetically functional fluid in the orifice passage by suppressing the passage width or passage cross-sectional area of the orifice passage in which the magnetic flux concentrating member is disposed on the wall portion.

In the present aspect, “parallel” excludes an aspect in which all the orifice passages causing the first fluid chamber and the second fluid chamber to communicate with each other are connected in series, and does not mean that the plurality of orifice passages is disposed in parallel in shape. That is, in the present aspect, the plurality of orifice passages may be disposed in parallel in the axial direction, for example, may be disposed in parallel on both sides in the radial direction as illustrated in an eleventh aspect which will be described later, or may cause the first fluid chamber and the second fluid chamber to communicate with each other at different positions and in different shapes. Further, it is not necessary that all of the plurality of orifice passages be disposed in parallel, and for example, if two orifice passages are disposed in parallel, the remaining orifice passages may be connected in series.

According to a ninth aspect, in the fluid-filled type vibration isolating device of the eighth aspect, the plurality of orifice passages is configured to include a plurality of orifice passages having the same cross-sectional area.

In the fluid-filled type vibration isolating device having the structure according to the present aspect, it is possible to provide a plurality of orifice passages having the same cross-sectional area, for example, with the same passage length. As a result, the fluid flow states in the plurality of orifice passages become substantially equal, and thus tuning becomes easy, or the fluid flow action through the plurality of orifice passages can be utilized more efficiently.

According to a tenth aspect, in the fluid-filled type vibration isolating device of the eighth or ninth aspect, the plurality of orifice passages is configured to include an orifice passage having a cross-sectional area different from that of another orifice passage.

The plurality of orifice passages having different cross-sectional areas, which is employed in a fluid-filled type vibration isolating device having the structure according to the present aspect, may have the same passage length or may have different passage lengths according to desired vibration isolation properties and the like. In the vibration isolating device according to the present aspect, for example, tuning frequencies (liquid column resonance frequencies) of the orifice passages having different passage cross-sectional areas may be made different according to the input vibration such that the vibration isolating effect of each orifice passage is exhibited with respect to the input vibrations in a plurality of frequency ranges. Alternatively, it may be possible to improve the vibration isolating performance by lowering a dynamic spring, for example, by reducing the pressure fluctuation accompanied with the vibration input in the fluid chamber using the overall fluid flow action of the orifice passages having different cross-sectional areas.

According to an eleventh aspect, in the fluid-filled type vibration isolating device of any one of the eighth to tenth aspects, the first fluid chamber and the second fluid chamber are provided on both sides in a direction perpendicular to an axis, and the plurality of orifice passages is configured to include an orifice passage through which the first fluid chamber and the second fluid chamber communicate with each other in the circumferential direction on both sides of the first fluid chamber in the circumferential direction.

According to the fluid-filled type vibration isolating device having the structure according to the present aspect, it is possible to provide a plurality of orifice passages using spaces on both sides of the first fluid chamber in the circumferential direction, and it is possible to efficiently dispose the plurality of orifice passages in a small space without increasing the size of the vibration isolating device.

According to a twelfth aspect, in the fluid-filled type vibration isolating device of any one of the fifth to eleventh aspects, the magnetic flux concentrating member has both side facing wall portions disposed to face each other on both sides of the orifice passage in a width direction, and a continuous portion which is partially provided in a length direction of the orifice passage and connects the both side facing wall portions to each other.

According to the fluid-filled type vibration isolating device having the structure according to the present aspect, it is possible to configure the magnetic flux concentrating member as one member while securing a magnetic force action on the magnetically functional fluid in the orifice passage due to a magnetic flux concentrating action of the both side facing wall portions, and thus it is possible to reduce the number of components, to facilitate the manufacturing, and to simplify the structure.

According to a thirteenth aspect, in the fluid-filled type vibration isolating device of the twelfth aspect, the magnetic flux concentrating member is formed as the continuous portion by the both side facing wall portions being integrated with each other on at least one end portion side of the orifice passage in the length direction.

In the fluid-filled type vibration isolating device having the structure according to the present aspect, for example, as in an embodiment which will be described later, it is possible to provide a continuous portion at a position deviated from the orifice passage in the circumferential direction, or to provide a continuous portion at a position deviated inward in the radial direction from the both side facing wall portions that constitute the both walls of the orifice passage. In this way, in the end portion side of the orifice passage in the length direction, it is possible to set a continuous portion with a relatively high degree of freedom in design regarding the shape, position, and the like.

According to a fourteenth aspect, in the fluid-filled type vibration isolating device of any one of the fifth to thirteenth aspects, the magnetic field generating unit includes a yoke member that forms a magnetic path which is open to an inner circumferential side toward the outer tube member, and the entire axial length of the magnetic flux concentrating member constituting both side wall portions of the orifice passage is equal to or greater than an axial length on the inner circumferential side which is open in the yoke member.

According to the fluid-filled type vibration isolating device having the structure according to the present aspect, it is possible to effectively prevent the magnetic flux which is exerted on the orifice passage through the yoke member from the magnetic field generating unit from leaking to the outside and to more efficiently exert it between both side wall portions of the magnetic flux concentrating member and the orifice passage.

According to a fifteenth aspect, in the fluid-filled type vibration isolating device according to any one of the first to fourteenth aspects, the magnetic field generating unit is annular and is externally fitted with respect to the outer tube member to be disposed thereon.

According to the fluid-filled type vibration isolating device having the structure according to the present aspect, the magnetic field generating unit can be easily positioned with respect to the outer tube member in the direction perpendicular to the axis. Further, it becomes easy to employ a structure that does not require positioning of the magnetic field generating unit and the outer tube member in the circumferential direction.

According to a sixteenth aspect, in the fluid-filled type vibration isolating device of any one of the first to fifteenth aspects, an intermediate sleeve formed of a non-magnetic material is fixed to an outer circumferential portion of the main body rubber elastic body and the outer tube member is externally fitted with respect to the intermediate sleeve to be fixed thereto, and a region for forming the orifice passage is provided between the intermediate sleeve and the outer tube member.

According to the fluid-filled type vibration isolating device having the structure according to the present aspect, the magnetic flux line of the magnetic field exerted from the magnetic field generating unit is less likely to escape to the inner circumferential side of the orifice passage, and the magnetic field is more efficiently exerted on the orifice passage.

According to the present invention, it is possible for a fluid-filled type vibration isolating device to realize excellent vibration isolating performance by controlling properties with a simple structure.

What is claimed is:

1. A vibration isolating device, which is a fluid-filled type and in which an inner shaft member and an outer tube member are connected to each other with a main body rubber elastic body and a plurality of fluid chambers filled with a fluid is provided to be separated from each other in a circumferential direction and communicates with each other through an orifice passage, wherein the fluid is a magnetically functional fluid,
the outer tube member is a non-magnetic material,
a tubular cover member is disposed to be separated toward an outer circumferential side from the outer tube member,
a magnetic field generating unit that exerts a magnetic field on the magnetically functional fluid is assembled between the outer tube member and the tubular cover member, and
one side member and another side member to be connected to each other in a vibration isolating manner are configured to be attached to the inner shaft member and the tubular cover member.

2. The vibration isolating device according to claim 1, wherein the tubular cover member is a non-magnetic material.

3. The vibration isolating device according to claim 1,
wherein an outer circumferential surface of the magnetic field generating unit is superposed on the tubular cover member via an outer circumferential elastic layer, and
the magnetic field generating unit is sandwiched between the outer tube member and the tubular cover member in a direction perpendicular to an axis.

4. The vibration isolating device according to claim 1,
wherein an end portion elastic body is arranged on at least one side of the magnetic field generating unit in an axial direction, and
the magnetic field generating unit is positioned in the axial direction by the outer tube member and the tubular cover member via the end portion elastic body.

5. The vibration isolating device according to claim 1, wherein the magnetic field generating unit is annular and is externally fitted with respect to the outer tube member to be disposed thereon.

6. The vibration isolating device according to claim 1,
wherein an intermediate sleeve formed of a non-magnetic material is fixed to an outer circumferential portion of the main body rubber elastic body and the outer tube member is externally fitted with respect to the intermediate sleeve to be fixed thereto, and
a region for forming the orifice passage is provided between the intermediate sleeve and the outer tube member.

7. A vibration isolating device, which is a fluid-filled type and in which an inner shaft member and an outer tube member are connected to each other with a main body rubber elastic body and a plurality of fluid chambers filled with a fluid is provided to be separated from each other in a circumferential direction and communicates with each other through an orifice passage, wherein
the fluid is a magnetically functional fluid,
the outer tube member is a non-magnetic material,
a magnetic field generating unit that exerts a magnetic field on the magnetically functional fluid is mounted on an outer circumferential side of the outer tube member, and
a magnetic flux concentrating member formed of a ferromagnetic material is disposed on a wall portion of the orifice passage.

8. The vibration isolating device according to claim 7, wherein, in a portion of the orifice passage that extends in the circumferential direction, the magnetic flux concentrating member is disposed on each of side wall portions on both sides facing each other in an axial direction.

9. The vibration isolating device according to claim 7,
wherein the magnetic flux concentrating member is disposed in a portion of the orifice passage that extends in the circumferential direction, and
in the magnetic flux concentrating member, an axial dimension in an inner circumferential portion is larger than that in an outer circumferential portion.

10. The vibration isolating device according to claim 7,
wherein, as the plurality of fluid chambers, a first fluid chamber and a second fluid chamber are provided,
as the orifice passage, a plurality of orifice passages through which the first fluid chamber and the second fluid chamber communicate with each other in parallel is provided, and
the magnetic flux concentrating member formed of a ferromagnetic material is disposed on a wall portion in at least one of the orifice passages.

11. The vibration isolating device according to claim 10, wherein the plurality of orifice passages is configured to have a same cross-sectional area.

12. The vibration isolating device according to claim 10, wherein the plurality of orifice passages is configured to include an orifice passage having a cross-sectional area different from that of other orifice passages.

13. The vibration isolating device according to claim 10,
wherein the first fluid chamber and the second fluid chamber are provided on both sides in a direction perpendicular to an axis, and
the plurality of orifice passages is configured to include an orifice passage through which the first fluid chamber and the second fluid chamber communicate with each other in the circumferential direction on both sides of the first fluid chamber in the circumferential direction.

14. The vibration isolating device according to claim 7,
wherein the magnetic flux concentrating member has
both side facing wall portions disposed to face each other on both sides of the orifice passage in a width direction, and
a continuous portion which is partially provided in a length direction of the orifice passage and connects the both side facing wall portions to each other.

15. The vibration isolating device according to claim 14,
wherein the magnetic flux concentrating member is formed as the continuous portion by the both side facing wall portions being integrated with each other on at least one end portion side of the orifice passage in the length direction.

16. The vibration isolating device according to claim 7,
wherein the magnetic field generating unit includes a yoke member that forms a magnetic path which is open to an inner circumferential side toward the outer tube member, and
an entire axial length of the magnetic flux concentrating member constituting both side wall portions of the orifice passage is equal to or greater than an axial length on the inner circumferential side which is open in the yoke member.

17. The vibration isolating device according to claim 7, wherein the magnetic field generating unit is annular and is externally fitted with respect to the outer tube member to be disposed thereon.

18. The vibration isolating device according to claim 7,
wherein an intermediate sleeve formed of a non-magnetic material is fixed to an outer circumferential portion of the main body rubber elastic body and the outer tube member is externally fitted with respect to the intermediate sleeve to be fixed thereto, and
a region for forming the orifice passage is provided between the intermediate sleeve and the outer tube member.
